(19) United States
(12) Patent Application Publication
(10) Pub. No.: US 2019/0255566 A1
(43) Pub. Date: Aug. 22, 2019

(54) SYSTEM AND METHOD FOR 3D DECORATION OF METALS ACCORDING TO A PATTERN

(71) Applicant: UNIVERCOL PAINTS LTD, Netanya (IL)

(72) Inventors: Israel MICHAL, Givat Shmuel (IL); Ran MANO, Lapid (IL); Assi HINDI, Hertzelia (IL)

(21) Appl. No.: 16/400,050

(22) Filed: May 1, 2019

Related U.S. Application Data
(63) Continuation-in-part of application No. 15/623,403, filed on Jun. 15, 2017.
(60) Provisional application No. 62/363,860, filed on Jul. 19, 2016.

(51) Int. Cl. B05D 7/00; B05D 1/04; B05D 3/14; B05D 3/10; B05D 1/06; B05D 3/04; B05D 7/14; B05D 3/06; B05D 5/06

(52) U.S. Cl. CPC B05D 7/542; B05D 2350/60; B05D 3/14; B05D 3/102; B05D 1/06; B05D 3/0406; B05D 7/14; B05D 3/067; B05D 5/061; B05D 2202/15; B05D 2202/25; B05D 2202/45; B05D 2508/00; B05D 2503/00; B05D 2502/00; B05D 1/045

(57) ABSTRACT

A method for forming a metal substrate with 3D decorations according to a predetermined pattern, on at least one face of the metal substrate including: determining drop size of primer for defining thickness of a 3D decoration, applying the primer according to a predetermined pattern onto at least one face of a metal substrate, applying thereto an electrostatic thermal curing powder coating comprising color, removing excess of electrostatic thermal curing powder coating such that the thermal curing coating remains only at a location on the metal substrate determined by the primer, inserting the metal substrate into a convection oven, and forming a metal substrate with 3D decorations according to the predetermined pattern on the at least one face of the metal substrate, and a system for performing the same.

### FIELD OF THE INVENTION

The present invention relates to a system and method of applying color on metals, and more specifically to applying 3D decoration on metals according to a particular pattern.

### BACKGROUND

Nowadays, painting metals is generally performed using thermal curing powder coating, which is an environmentally-friendly painting method compared to painting using paint that includes solvent. The powder is charged with positive electrical charge while sprayed through an electrostatic powder gun, and is evenly spread onto the metal object. The metal object is then heated, the powder melts into a uniform film, and finally the metal object is cooled such that the powder forms a hard coating. Typically, the powders cure at 200° C. for a period of approximately 10 minutes following the metal reaching its melting temperature point. Heating the metal object is typically accomplished by convection cure ovens.

However, this technique is limited to coloring an entire metallic object in one shade of color only, since it is impossible to control powder sprayed onto a portion of the object. Instead, powder sprayed onto a metal object results in a uniform and even spread all over the object, as the electrically charged powder is attracted to the metal object and, for example, reaches the back side of the object even when only the front side of the object is sprayed with the powder.

Accordingly, this technique doesn't enable decorating a metallic object with certain 3D predefined shapes and patterns, for the same reason that powder spraying, and more specifically spraying electrostatic powder on metal objects, is impossible to control with respect to shape or pattern, location along metallic object and thickness of the shape or pattern along the metallic object.

To enable painting and in addition 3D decoration of a metal object in one or more colors, according to a particular pattern, has great potential in the design and building market. For example, if a designer or builder were able to offer a client to design metal extrusions incorporated in their building, such that the external side of the extrusion is colored with one color (with or without 3D decorations in any color), while the side of the extrusion directed to the inside of the building may be colored with a second different color (with or without 3D decorations in any color), the possibilities may be endless, and may be adjusted per each client's preferences and desires.

There is therefore a need for a system and method that enable 3D decoration of metals with one or more colors, in an industrially applicable manner.

### SUMMARY

An industrially applicable system and method for 3D decorating metal objects according to a particular pattern with one or more colors are provided.

The 3D patterned decoration may either be of the same color as the metallic object is initially colored at, using thermal curing, or the color of the 3D pattern may be of a different color than the color of the metallic object.

According to some embodiments, a method for forming a metal substrate with 3D decorations according to a predetermined pattern, on at least one face of the metal substrate, may comprise:

(a) determining drop size of primer for defining thickness of a 3D decoration;
(b) applying the primer according to a predetermined pattern onto at least one face of a metal substrate;
(c) applying thereto an electrostatic thermal curing powder coating comprising color;
(d) removing excess of electrostatic thermal curing powder coating such that the electrostatic thermal curing powder coating remains only at a location on the metal substrate determined by the primer;
(e) inserting the metal substrate into a convection oven; and
(f) forming a metal substrate with 3D decorations according to the predetermined pattern on the at least one face of the metal substrate.

According to some embodiments, the primer may be a thermal based primer.

According to some embodiments, the primer may be selected from a group of primers consisting of: UV based primers, solvent based primers and thermal based primers.

According to some embodiments, the method may comprise prior to applying the primer, entirely painting the metal substrate with a first color or entirely anodizing the metal substrate.

According to some embodiments, the step of entirely painting the metal substrate with a first color may comprise applying an electrostatic thermal curing powder coating comprising the first color.

According to some embodiments, the color of the electrostatic thermal curing powder coating may be the same as or different from the color of the metal substrate.

According to some embodiments, the step of removing excess of the electrostatic thermal curing powder may be performed using air blowing and a brushing unit.

According to some embodiments, the metal substrate may be made of a metal selected from a group consisting of: aluminum, iron, copper, steel, stainless steel, and an alloy thereof.

According to some embodiments, steps (a)-(e) may be repeated with at least one additional electrostatic thermal curing powder coating of a second color, as determined by a predetermined pattern.

According to some embodiments, the convection oven may be a transverse loading convection oven.

According to some embodiments, a system for forming a metal substrate with 3D decorations according to a predetermined pattern, on at least one face of the metal substrate, may comprise:

a device for applying a primer according to a predetermined drop size for defining thickness of a 3D decoration and further according to a predetermined pattern onto at least one face of a metal substrate;
a powder gun for spraying electrostatic thermal curing powder coating onto the primer, whereby said electrostatic thermal curing powder coating comprises color;
an air-gun for blowing air onto the electrostatic thermal curing powder coating and a brushing unit for brushing onto the metal substrate for removing excess of electrostatic thermal curing powder such that the electrostatic thermal curing powder coating remains only at the location on the metal substrate determined by the primer; and
a convection oven for curing the electrostatic thermal curing powder coating.

According to some embodiments, the metal substrate may be made of a metal selected from a group consisting of: aluminum, iron, copper, steel, stainless steel, and an alloy thereof.

According to some embodiments, the device for applying a primer may be a digital printer.

According to some embodiments, the primer may be a thermal based primer.

According to some embodiments, the primer may be selected from a group of primers consisting of UV based primers, solvent based primers and thermal based primers.

According to some embodiments, the color of the electrostatic thermal curing powder coating may be the same as or different from the color of the metal substrate.

According to some embodiments, the convection oven is a transverse loading convection oven.

According to some embodiments, the system may further comprise a second powder gun for entirely painting the metal substrate with a first color, prior to applying the primer.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1 is a schematic diagram of a system for decorating a metal substrate with at least two colors according to a predetermined pattern on at least one side of the metal substrate, according to embodiments of the disclosed subject matter;

FIG. 2 is a flowchart of a method for decorating a metal substrate with at least two colors according to a predetermined pattern on at least one side of the metal substrate, according to embodiments of the disclosed subject matter;

FIG. 3A is a schematic diagram illustrating the steps of decorating a metal substrate with at least two colors according to a predetermined pattern on one side of the metal substrate, according to embodiments of the disclosed subject matter;

FIG. 3B is a schematic diagram illustrating the steps of decorating a metal substrate with at least two colors according to a predetermined pattern on one side of the metal substrate, according to embodiments of the disclosed subject matter;

FIG. 4 is a schematic diagram illustrating the steps of decorating a metal substrate with at least a third color according to a predetermined pattern on one side of the metal substrate, according to embodiments of the disclosed subject matter;

FIG. 5 is a schematic diagram illustrating the steps of decorating a metal substrate with at least two colors according to a predetermined pattern on a second side of the metal substrate, according to embodiments of the disclosed subject matter;

FIG. 6 is a schematic illustration of a top-side view of a system for decorating a metal substrate with at least two colors according to a predetermined pattern on at least one side of the metal substrate, according to embodiments of the disclosed subject matter;

FIG. 7 is a schematic illustration of various metal profiles representing the variety of profiles that a system for decorating a metal substrate with at least two colors according to a predetermined pattern is required to color, according to embodiments of the disclosed subject matter;

FIG. 8 is a schematic illustration of a side view of a printing module that is included in a system for decorating a metal substrate with at least two colors according to a predetermined pattern, according to embodiments of the disclosed subject matter;

FIG. 9 is a schematic illustration of a bottom view of a printing module that is included in a system for decorating a metal substrate with at least two colors according to a predetermined pattern, according to embodiments of the disclosed subject matter;

FIG. 10 is a bottom view of the printing area of a system for decorating a metal substrate with at least two colors according to a predetermined pattern is required to color, according to embodiments of the disclosed subject matter;

FIG. 11 is a top view of a sliding cylinder that is part of a conveyer that pushes metal profiles into the printing module, according to embodiments of the disclosed subject matter;

FIG. 12 is a side view of a portion of the printing module, according to embodiments of the disclosed subject matter;

FIGS. 13A-13B are schematic illustrations of side-views of a powder coating and air-blowing module, without and with protecting side walls, respectively, according to embodiments of the disclosed subject matter;

FIG. 14 is a schematic illustration of a side view of a powder coating and air-blowing module, according to embodiments of the disclosed subject matter;

FIGS. 15A-15B are schematic illustrations of a respective top-side view of an IR and UV module, and of a respective side view of a securing opening and closing mechanism located at the entrance of the IR and UV module, respectively, according to embodiments of the disclosed subject matter;

FIG. 16 is a schematic illustration of a side view of IR and UV module, according to embodiments of the disclosed subject matter;

FIG. 17A-17B are schematic illustrations of a side view and a respective side view of a UV unit, respectively, according to embodiments of the disclosed subject matter;

FIG. 18 is a schematic diagram of a system for forming a metal substrate with 3D decorations according to a predetermined pattern on at least one side of the metal substrate, according to embodiments of the disclosure;

FIG. 19 is a flowchart of a method for forming a metal substrate with 3D decorations according to a predetermined pattern on at least one side of the metal substrate, according to embodiments of the disclosure;

FIG. 20 is a schematic illustration of a top-side view of a system for 3D decorating a metal substrate according to a predetermined pattern on at least one side of the metal substrate, according to embodiments of the disclosure;

FIG. 21 is a schematic illustration of a side view of a printing module that is included in a system for 3D decorating a metal substrate according to a predetermined pattern, according to embodiments of the disclosure;

FIG. 22A is a schematic diagram illustrating the steps of 3D decorating a metal substrate according to a predetermined pattern on one side of the metal substrate, according to embodiments of the disclosure;

FIG. 22B is a photograph of an example of 3D decorations applied onto a metal substrate, according to embodiments of the disclosure;

FIG. 23 is a photograph of additional examples of 3D decorations applied onto metal substrates, according to embodiments of the disclosure;

FIG. 24 is a photograph of examples of 3D decorations applied onto metal profiles, according to embodiments of the disclosure;

FIG. 25 is a schematic illustration of side-views of a powder coating and air-blowing module, without protecting side walls, according to embodiments of the disclosure;

FIG. 26 is a schematic illustration of a top-side view of a brushing system, according to embodiments of the disclosure;

FIGS. 27A-27B are schematic illustrations of a perspective view and a front view, respectively, of a brushing unit, according to embodiments of the disclosure;

FIG. 28 is a schematic illustration of a front view of a brushing unit with respect to a metallic substrate, according to embodiments of the disclosure;

FIG. 29 is a schematic illustration of a suction unit, according to embodiments of the disclosure; and

FIG. 30 is a schematic illustration of a top view of a transverse loading convection oven, according to embodiments of the disclosure.

### DETAILED DESCRIPTION

In the context of the present disclosure, without limiting, the term ‘substrate’ relates to a base material that paint or primer may be applied onto.

In the context of the present disclosure, the term ‘object’ relates to anything that paint or primer may be applied onto.

In the context of the present disclosure, without limiting, the term ‘primer’ relates to a preparatory coating that is applied on a substrate that may be initially anodized or initially painted at a certain first color, prior to painting the substrate with a second color, which may be the same as or different from the first color. The pattern at which the primer is applied onto the painted substrate defines the pattern of the second color that is to be applied onto the primer.

In the context of the present disclosure, without limiting, the term ‘digital printing’ relates to a method of printing a pattern onto a substrate, in accordance with a predetermined digital-based image. In the context of the present disclosure, a digital printer prints a primer onto the object according to the pattern of the digital-based image.

In the context of the present disclosure, without limiting, the term ‘entirely painted’ relates to at least an entire side or face of a substrate or an object uniformly covered all over the side or face of the substrate or object, with at least one layer of color.

In the context of the present disclosure, the term ‘predetermined pattern’ relates to any shape or pattern or contour of a visual ornament or decoration according to which primer and paint may be applied onto a substrate or object, which may be predetermined or predefined prior to application of the primer and paint. The predetermined pattern includes a shape or pattern or contour which shows the color painted according to the predetermined pattern, as well as the color of the substrate or object prior to application of the predetermined pattern. The predetermined pattern also includes a shape or pattern which only shows the color painted according to the predetermined pattern, without showing the color of the substrate or object prior to application of the predetermined pattern. That is, the predetermined pattern includes a pattern according to which primer and paint are applied onto an entire side or face of a substrate or object, such that the substrate or object are uniformly coated all over their entire side or face with primer and paint.

In the context of the present disclosure, the term ‘3D decoration’ or ‘3D painting’ relates to any shape or pattern or contour of a visual ornament or decoration that has thickness and which is protruding in a predetermined degree above the surface of the substrate, whether or not the substrate is initially painted with a first color or whether it is anodized prior to applying 3D decoration.

The terms cited above denote also inflections and conjugates thereof.

Industrial painting methods of metals typically include using thermal curable powder coating that are sprayed onto a metal object by an electrostatic gun. This is a preferred method of painting metal objects since the powder is charged with positive charge while being sprayed onto the metal object, which causes the powder to electrically attract to the metal object and thus cover it in a uniform and homogenous manner. Since the powder is attracted to the metal object, the powder that is sprayed on one side of the metal object, independently reaches and is applied onto the opposite side of the metal object as well, though in a less homogenous manner, and there is a need to spray the powder directly onto the opposite side in order to achieve the same uniform coat as that of the first side. Thus, a painting method based on electrostatic powder enables very little control over painting the metal object with more than one color, e.g., painting one side of a metal object with one color, while painting another side of the metal object with a different color, let alone painting the metal object according to a predetermined pattern.

There is therefore a need for an industrially applicable system and method for painting and decorating metal objects with more than one color according to a predetermined pattern at a certain thickness above the surface of the metal object on at least one side of the metal object.

UV curable powder coatings are melted by exposure to IR energy. This process takes several seconds with a required final temperature of 90-200° C. of the surface of the object being coated. This melting process of UV curable powder coatings by IR requires lower energy consumption compared to the melting process of thermal curing powder coatings, since with thermal powder coatings the entire object that is being coated is to be heated to a temperature of 200° C. in order for the thermal curing powder coating to melt, which takes much longer to happen and thus requires more energy than merely heating the surface of the object to up to about 200° C. Crosslinking or curing of the melted UV powder occurs by exposure to UV light for only a few seconds. Thus, the total curing time amounts to only a few minutes, e.g., approximately 1-2 minutes, which is much faster compared to curing time of thermal curing powder coating. Therefore, use of UV curable powder coating for painting metal objects benefits from the advantage of shorter time till end of curing, at least as compared to thermal curing.

Digital printing enables accurate printing of any particular pattern and shape in accordance to a predefined digital-based image, while avoiding the costly need to manufacture a mask, stamp or printing plate per each pattern or shape that is to be applied onto an object. Therefore, printing a primer using a digital printer may enable printing the primer at a precise predefined pattern or shape onto a side or a face of a metal object that has already been colored with a first color, in order to create a metal object decorated with at least two colors in accordance with a predetermined pattern. The primer should be configured to enable such precise printing. Thus, the primer should be designed to have specific viscosity and stickiness characteristics that would enable precise application of the primer onto the metal object via a digital printing device. There is a delicate balance between the primer having high viscosity such to be applied accurately by the printing device according to the predetermined pattern (so the primer is not too thin, which might cause it to not stay at the proper location according to the predetermined pattern), while the primer not being too viscous, which would make it difficult for the primer to exit through the nozzles of the printing device.

Following printing of the primer at a desired pattern or shape onto the side or face of the metal object. UV curable powder coating comprising a second color may be sprayed onto the printed side of the object. Powder coating spreads uniformly onto the printed side of the sprayed metal object, thus excess of the powder that is not attached to the primer is required to be removed. Typically, removal of excess of powder may be performed using air blowing. Finally, the printed side of the metal object is exposed to IR light and to UV light, which cure the UV powder coating according to the predefined pattern at which the primer was printed onto the metal object. A metal object decorated with at least two colors according to a particular pattern is then formed.

According to one example, the pattern according to which the primer is applied onto the metal object may include the entire area of one side of the metal object, such that, one side or one face of the metal object is entirely painted with the color initially painted onto the metal object (the first color applied), while the other side or face is entirely painted with the second color of the UV curable powder. According to other examples, the pattern may include any kind of visual ornament or decoration that may show the second color of the UV curable powder as well as the first color initially painted onto the metal object. The pattern may include more than two colors, such that a primer may be printed and UV powder coating may be applied a plurality of times, as required to accomplish a multi-colored pattern.

A general non-limiting presentation of practicing the present disclosure is given below, outlining exemplary practice of embodiments of the present disclosure and providing a constructive basis for variant and/or alternative embodiments, some of which are subsequently described.

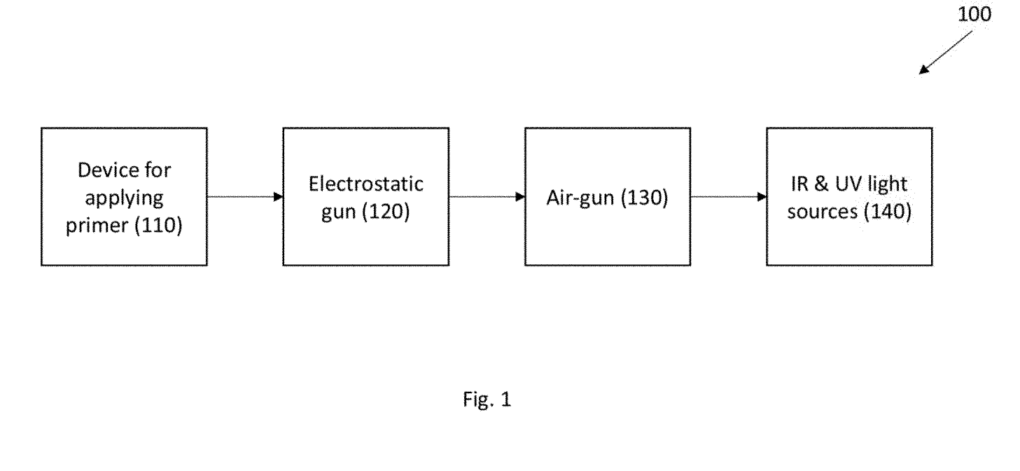

Reference is now made to FIG. 1, which is a schematic diagram of a system 100 for decorating a metal substrate with at least two colors according to a predetermined pattern on at least one side of the metal substrate, according to exemplary embodiments of the disclosed subject matter. According to some embodiments, the metal substrate may be made of any metal or alloy, for example, aluminum, iron, copper, steel and/or stainless steel. Any other metal may also be decorated with more than one color according to the disclosed subject matter. Typically, the metal substrate is initially painted with a thermal curable powder coating comprising a first color. The powder coating is sprayed onto the metal object via an electrostatic gun, such that the powder is attracted to the metal object and creates a uniform coating over the metal object. In other embodiments, the metal object may be painted with a first color via other methods of painting, e.g., anodizing coating process.

According to some embodiments, system 100 may comprise a device 110 for applying a primer onto a metal substrate or metal object. Device 110 may be configured to apply the primer onto the metal object according to a predefined or predetermined pattern. The predefined pattern may be selected by any person whom the painting and decorating of the metal object is for. The predetermined pattern according to which the primer is applied onto the metal object may be any kind of visual ornament or decoration, and in some embodiments may include a uniform covering of one side or face of the metal substrate. Typically, a digital file of the predetermined pattern is prepared, such that primer may be applied onto the metal object accordingly.

Preferably, device 110 may be a digital printer for digitally printing the primer according to a predetermined digital-based image. Digital printers that may be used to accomplish printing of a primer may be inkjet type printers, e.g., digital inkjet printers manufactured by Xerox, Fuji, Konica Minolta, Kyocera, etc. Such digital printers are required to be adjusted to printing primer instead of ink. For example, clogging of the nozzles of such printers may occur due to remains of dry primer. Primer may dry within the nozzles of the printers if primer is not continuously flowing through the nozzles, which may be the case when conforming the exit of the primer from certain nozzles to the predefined pattern of the digital-based image. In order to overcome such clogging of the nozzles of a digital printer, predetermined time periods for cleaning the nozzles of the printing system may be defined. The time periods at which cleaning of the printing system may take place, may be determined by the typical time it takes the primer to dry. Furthermore, implementing a thermal control unit in the printing system may assist in controlling the viscosity of the primer, thereby preventing it from drying and clogging the nozzles of the printing system.

In some embodiments, the pattern according to which the primer is applied, further defines the final pattern of the second color that is to be applied onto the primer.

In some embodiments, the primer that is applied onto the metal substrate may be any type of a UV based primer, a solvent based primer or a thermal based primer. A UV based primer may be a primer that changes its state from fluid (which is the state in which the primer is applied onto the metal substrate) to “sticky” (which is the state that enables other materials to adhere to it, e.g., the powder coating, as described hereinafter) only after activation via UV energy, e.g., after being positioned under a UV energy source. A solvent based primer may be a primer that changes its state from fluid to sticky following evaporation of the solvent. A thermal based primer may be a primer that changes its state from fluid to sticky after being thermally heated.

Since the sticky state of the primer is the state required for adhesion of a powder coating to the primer, it is beneficial to have the primer reach its sticky state soon after the primer is applied onto the metal substrate. This also ensures that the surface of the metal substrate that is now applied with primer, is smooth and aesthetic. When using a UV based primer, one method of accomplishing the primer reaching its sticky state soon after it is applied onto the metal substrate, includes verifying that an intensity of the UV energy activating the primer is sufficiently high, e.g. above a predetermined threshold.

On the other hand, the time till the second color (e.g., powder coating comprising the second color, as described hereinafter) is applied onto the primer is required to be soon after the primer has become sticky, in order to avoid a scenario of applying the second color onto a dry primer, which will not result with adhesion of the second color to the primer.

In some embodiments, system 100 may further comprise a powder coating injecting gun 120. 120. Powder coating gun 120 may be configured to spray a powder coating comprising a second color, onto the primer. In some embodiments, injecting gun 120 may be an electrostatic gun, which may be configured to spray the powder coating comprising the second color onto the primer, while charging the powder with positive electrical charge.

Preferably, the powder coating may be a UV curable powder coating, in order to enable working with lower energy compared to that used for curing thermal curable powder coatings, as well as shorten the curing time compared to that required per thermal curable powder coatings. However, in other embodiments, the powder coating may be a thermal curable powder coating or any other type of powder coating.

Some examples for powder coatings that may be applied onto the primer are polyester, polyester dry blend, superdurable resin, polyurethane, polyester, and acrylics. Powder coatings such as the ones mentioned, as well as others, may differ from one another in their durability to impact, to humidity, and to oxidization, and in their level of gloss, among other characteristics. Thus, the surface tension of each of the powder coatings is different, and should be taken into consideration with respect to the level of surface tension of the primer when applied onto the metal substrate, such that the difference between surface tension of a powder coating and that of the primer is not significant, which may prevent a homogenous layer of color from coating the metal substrate. Therefore, the primer is required to have a surface tension that conforms to those of the powder coatings, such to be of the same range.

Another requirement of the primer concerns impact. AN powder coatings used for coloring metal substrates that are intended to be implemented as part of exterior surfaces, e.g., exterior surfaces of buildings, conform to standards of weather durability (e.g., durability to humidity, temperature and temperature changes, sun light, etc.), mechanical durability, and any other standard of the sort. Thus, all powders are found to have high impact durability during impact tests. The powder coating initially used to paint a first colored layer onto the metal substrate is connected to the metal substrate by mechanical and physical connections. However, once a primer is used, the connections between the primer and the first colored layer, as well as connections between the primer and the second colored layer, are chemical connections, which are stronger than mechanical and/or physical connections, and which may thus harm the strength of the connection between the first colored layer and the metal substrate. In order to ensure that the primer has high impact durability similarly to the impact durability of the powder coatings, and thus to enable the primer to absorb some of the energy or impact such that the first colored layer would stay intact and property connected to the metal substrate, materials comprising high elasticity may be added to the primer, for example, resin may be added to the primer. By increasing the elasticity of the primer, the primer's impact durability is raised. In other examples, the adhesion force or adhesion connection between the primer and the first colored layer may be lowered, in order to prevent the primer from weakening the impact durability of the first colored layer.

According to some embodiments, it is important that the primer, and thus the entire painted metal object have good durability under external conditions of the environment for a long time period. For example, the metal object should be designed to withstand extreme weather changes without them causing any harm to the strength and durability of the painted metal object.

When using electrostatic powder coating injecting gun 120 for applying powder coating comprising a second color, the powder attaches to the metal object, thus typically covering the entire side of the metal substrate onto which the powder is sprayed. Furthermore, the powder may also cover at least some of the metal object's sides that are not in direct contact with the sprayed powder coating, e.g., a side that is opposite to the side or face onto which the powder is sprayed. In order to remove excess of the powder coating and thus maintain the powder coating only at the location on the metal object defined by the applied (e.g., printed) primer's location, system 100 may further comprise a compressed air-gun 130. Air-gun 130 may comprise multiple nozzles which air is pressurized therethrough. Air should be pressurized through air-gun 130 at a high pressure, e.g. around 6-8 bar, in order to properly remove the powder coating from the metal substrate, thus removing all powder coating from all around the metal substrate or metal object, except for the powder that is attached onto the primer. That is, the pressure of air-gun 130 should be lower than the strength of the connection between the powder comprising the second color and the primer. Air-gun 130 may be required to move around the metal substrate or object in order to ensure that all excess of the powder is removed from all portions of the substrate or object. In some embodiments, air-gun 130 may comprise a tank for maintaining high pressure of the compressed air, which is to be pressurized out of the nozzles of air-gun 130. Compressed air is preferably used for removing excess of powder that is not attached to the primer, since air blowing is a very efficient and quick method for removing excess of material, which requires little or no human involvement. In other embodiments, other methods of removing excess of powder that is not attached to the primer may be used, for example, brushing excess of powder using special brushes. In which case, instead of air-gun 130, system 100 may comprise other corresponding devices for removing excess of powder, e.g., brushes. In some embodiments, the excess of powder may be collected by a designated suction unit. According to some embodiments, the collected excess of powder may be re-used for future powder coating.

It is important to avoid any finger prints or any other materials with higher surface tension than that of the powder coating, which may leave marks such as sweaty, fatty or greasy marks from contacting the metal substrate. Fat, grease or sweat may adhere the powder coating such that even after air-blowing the excess of powder that is not attached to the primer, some of the powder coating may still stay attached to the metal substrate in areas where fat, grease or sweat were present, thus interrupting with cleanliness and precision of the predefined pattern. Therefore, in some embodiments, the production line may comprise a cleaning unit for cleaning the surface of the metal substrate after loading the metal substrate onto the production line (and prior to applying the primer) such to ensure a highly clean substrate and high quality of products.

Following removal of excess of powder, such that powder coating remains only at the location on the metal substrate or object defined by the primer, the powder needs to go through a curing process in order to form a strong and stable attachment with the metal substrate (or object, e.g., a metal profile). Preferably, the powder coating is UV curable powder coating, such that the powder is curable via application of IR and UV energy. Therefore, system 100 may comprise IR and UV energy sources 140, for curing the UV curable powder to the metal substrate according to the pattern defined by the primer and to which the powder has attached. The metal substrate may be placed into a device comprising IR and UV energy sources 140, in order to initiate the curing process. IR light causes the powder to melt and UV light causes the powder to cross-link with the metal substrate.

Since curing using IR and UV light is a quicker process than that using thermal energy, and since it further requires lower energy to accomplish curing, the powder coating used for painting the second color onto the metal substrate is preferably UV curable powder coating. Use of UV curable powder coating allows for a shorter as well as industrially applicable method of painting a metal substrate with a second colored layer, according to a predefined pattern, on top of a first colored layer. However, it should be noted that since UV light rays are parallel to one another, they may only reach a surface that is perpendicular to the rays. Therefore, when using UV curable powder coating, it is important to apply the primer and then the powder coating on a flat surface that is to be positioned perpendicularly to the angle of emerging UV light rays. Other surfaces, which are part of the metal substrate and which are not perpendicular to the UV rays, may not be cured, such that a pattern may not be created at those locations along the metal substrate.

The metal substrate or object cools down and may then be incorporated as part of any structure, e.g., in the building industry. For example, a metal object, e.g., an aluminum extrusion that is colored with one color on one side, while colored with a second color and/or pattern comprising a second color on the other side (typically the side opposite the first side) may be implemented as part of a building, such that one side of the extrusion is part of the exterior of the building, and the other side of the extrusion is part of the interior of the building, while each side may have a completely different color and/or pattern. The method of painting a first layer of a first color on both sides of a metal object, and then painting a second layer with a second color, either on the entirety of at least one side of the metal object, or according to a predetermined pattern (defined by a primer onto which the second color is attached) on at least one side of the metal object, enables endless designs of metal objects; where one side or one face of the object has one design, defined by color and/or pattern, which may be completely different compared to the design of a different side or face of the metal object.

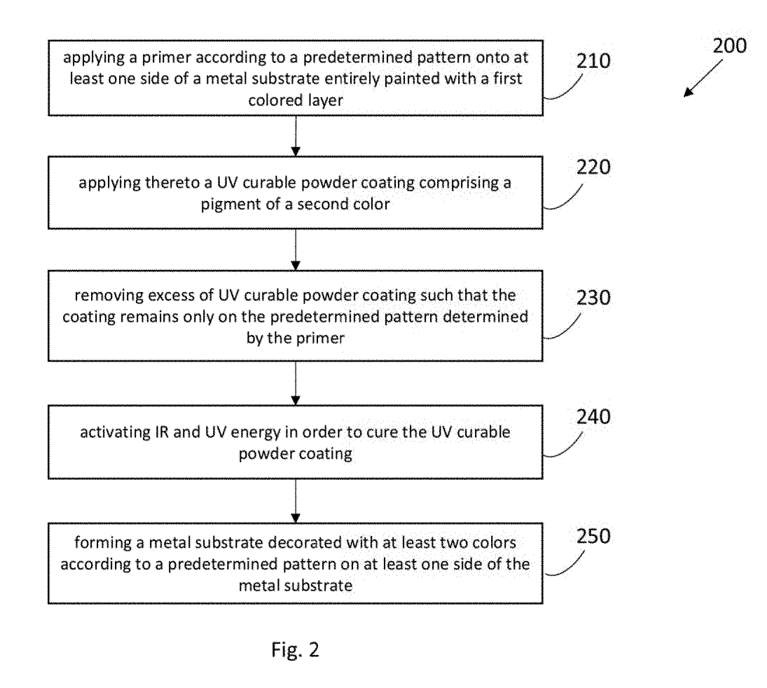

Reference is now made to FIG. 2, which is a flowchart of a method 200 for decorating a metal substrate with at least two colors according to a predetermined pattern on at least one side of the metal substrate, according to exemplary embodiments of the disclosed subject matter. Method 200 may comprise step 210 comprising applying a primer according to a predetermined pattern onto at least one side of a metal substrate entirely painted with a first colored layer. A metal substrate may initially be painted with a first colored layer. The metal substrate may be painted with the first color by any known method of painting metals, e.g., by using thermal curable powder coating, UV curable powder coating, or any other type of coating. The metal substrate is typically uniformly painted with the first color on all sides of the metal substrate.

In step 210, a primer is applied onto the colored metal substrate according to a predefined pattern, onto at least one side of the metal substrate, such that, for example, one side of the metal substrate may have a first color according to the first colored layer, while another side of the metal substrate may have a primer applied onto it in accordance with a particular pattern thus later causing that side to have a second colored layer according to a particular pattern. The primer is preferably applied via digital printing, though other methods of applying the primer may be implemented. Digital printing is a preferable method of applying the primer according to a predefined pattern, since digital printing is very precise and is quick enough to be used as part of a production line. The predefined pattern is loaded as a digital-based image onto a digital printer adjusted to printing primer. The primer is then digitally printed onto the metal substrate, thus defining the desired pattern that should appear on the metal substrate by the second colored layer.

System 200 may further comprise step 220, comprising applying a UV curable powder coating comprising a pigment of a second color, onto the metal substrate. In other embodiments, other types of powder coatings may be used, however, UV curable powder coatings are preferable, since they require lower energy and less time during the curing process, which is very cost effective. The UV curable powder coating is typically applied onto the metal substrate using a powder coating injecting gun, e.g., gun 120 in FIG. 1. Injecting the powder onto the metal substrate, causes the powder to attach onto the entire area of the side of the metal substrate that the powder is sprayed onto, and may even cause the powder to attach to other sides of the metal substrate. Thus, following application of the powder coating onto the metal substrate, there is no telling of which pattern the primer was printed according to.

Therefore, method 200 comprises step 230, which comprises removing excess of UV curable powder coating such that the coating remains only at a location determined by the primer. Step 230 of removing excess of the powder coating, typically UV curable powder coating, is an essential step to ensure powder coating comprising a second color remains only at the location defined by the primer, such that the pattern of the second colored layer is printed onto the metal substrate according to the predefined pattern with high precision and accuracy. Removal of excess of UV curable powder coating may be done using pressurized air, via an air-gun, e.g., air-gun 130, though other means may be used.

In some embodiments, method 200 may further comprise step 240, which comprises activating IR and UV energy in order to cure the UV curable powder coating. Since the powder coating is preferably UV curable powder coating, activation of IR and UV energy is required in order to accomplish curing of the powder coating so as to form a stable coating over the metal substrate. IR and UV energy is applied onto the coated metal substrate, via IR and UV energy sources, e.g., IR and UV energy sources 140. After a period of approximately 1-2 minutes under approximately 200° C., the powder is fully cured and is uniformly coated onto the metal substrate, according to the particular pattern the primer was printed.

In some embodiments, method 200 may comprise step 250 comprising forming a metal substrate decorated with at least two colors according to a predetermined pattern on at least one side of the metal substrate. At the end of method 200, a metal substrate may be decorated such that each of the sides of the metal substrate is decorated with a different design. For example, one side of the metal substrate may comprise a first colored layer (e.g., according to the layer of color used to color the entire metal substrate, prior to the beginning of method 200), whereas another side of the metal substrate (typically an opposite side) may comprise a second colored layer according to a pattern, in addition to the first colored layer. The pattern according to which the second colored layer may be applied onto at least one side of the metal substrate, may be any visual decoration which may or may not show the first colored layer therethrough. In some embodiments, the pattern may be a multi-colored pattern comprising more than two colors. Thus, the primer may be applied onto the metal substrate colored with a first colored layer, in repeating steps. During each step, the primer may be applied onto the metal substrate per one color that is to be painted thereto. That is, the pattern may be divided into pattern portions corresponding to the number of colors that the pattern is made of. In each step, primer is applied/printed onto the metal substrate according to the pattern portion related to one of the colors. The corresponding powder coating comprising that color may then be applied onto the primer, excess of powder is removed, and the remaining powder is cured. Then primer is applied/printed onto the metal substrate according to a different pattern portion relating to a different color, and the process is repeated until the entire pattern is applied onto the metal substrate.

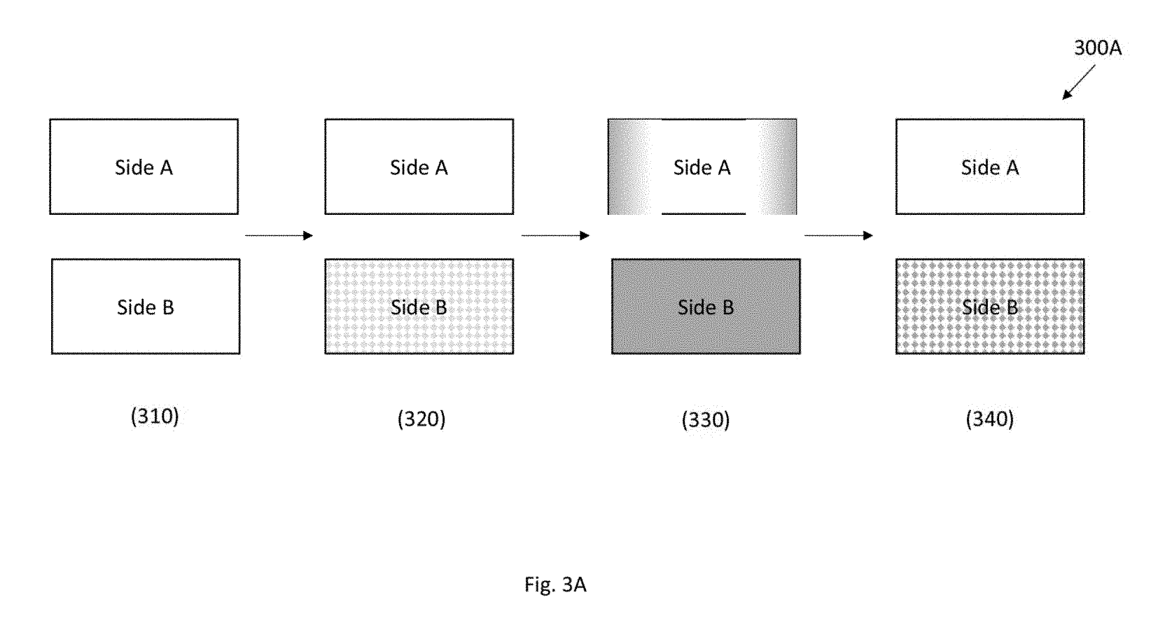

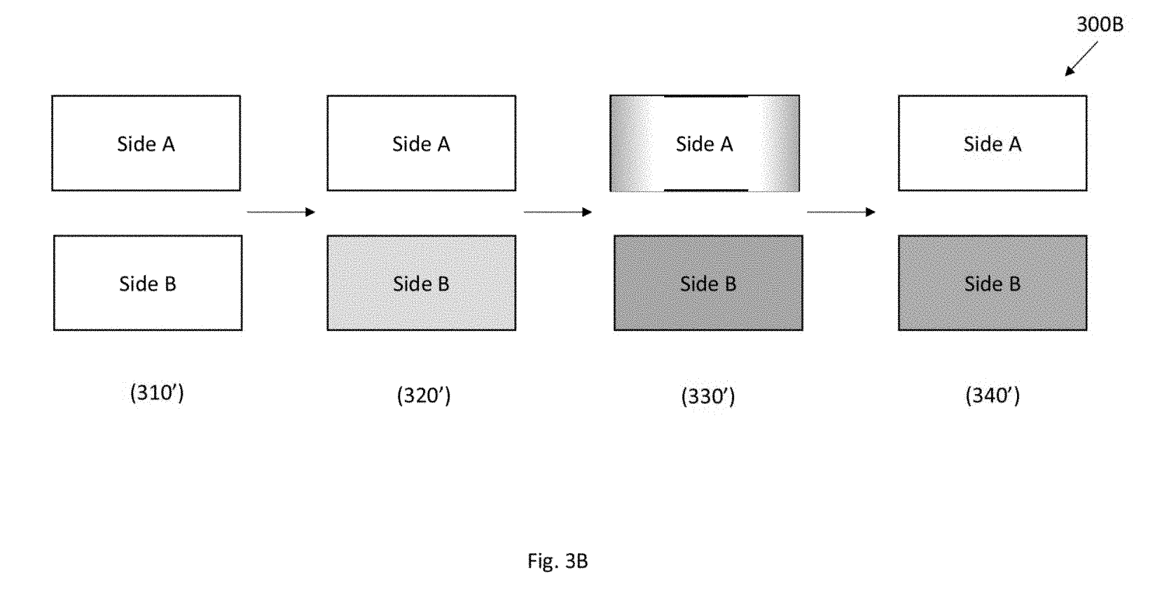

Reference is now made to FIG. 3A, which is a schematic diagram 300A illustrating the steps of decorating a metal substrate with at least two colors according to a predetermined pattern on one side of the metal substrate, according to exemplary embodiments of the disclosed subject matter. In step 310, a metal substrate comprising two sides is entirely painted with a color layer, such that side A and side B are colored with a first colored layer. For example, the first colored layer may be white, though any other color may be coated onto sides A and B. In step 320, primer is applied onto side B only. Primer may be applied onto side B by digital printing, and may be applied according to a predefined pattern. In the example illustrated in FIG. 3A, the pattern according to which the primer is applied onto side B of the metal substrate, may be an array of squares, which alternate between squares onto which primer is applied, and squares onto which no primer is applied, thus showing the color of the first colored layer. Other patterns may be implemented.

After printing or applying the primer onto side B of the metal substrate, a powder coating is applied onto side B in step 330. Typically, the powder coating is a UV curable powder coating, which may be sprayed via a powder coating injecting gun, e.g., gun 120. The powder may attach onto the metal substrate, thus coating side B in its entirety, and may even coat at least a portion of side A. In the example illustrated in FIG. 3A, the powder coating may coat side A in a non-uniform manner, e.g., to create a gradient of coated UV curable powder, on one or both ends of side A. The powder coating may comprise a second color, which is different from the color of the first colored layer. In the example illustrated in diagram 300A, the color of the second color is grey, though any other color may be used to color the metal substrate.

In step 340, the excess of powder coating is removed from all sides of the metal substrate in order to achieve a metal substrate colored with two colors according to a particular pattern. Removal of excess of powder coating may be performed by air blowing, e.g., using pressurized air blown onto the metal substrate via an air-gun, e.g., air-gun 130. The force of the pressurized air should be stronger than that of the attachment between the powder coating and the metal substrate, in those sections of the metal substrate where no primer is applied, thus the powder coating remains on side B only in those locations where the powder is attached to the primer. Following a curing process of the powder coating, a metal substrate colored with at least two colors according to a predetermined pattern on one side (e.g., side B), while the other side is colored with at least one color (e.g., side A), may be formed. In some embodiments, the powder coating may be UV curable powder coating, such that IR and UV curing is required in order to form a stable coating on the metal substrate. IR and UV curing may be performed via IR and UV energy sources, e.g., energy sources 140. In other embodiments other types of powder coatings may be used, e.g., thermal curable powder coatings, in which case curing may be performed via a convection cure oven.

Reference is now made to FIG. 3B, which is a schematic diagram illustrating the steps of decorating a metal substrate with at least two colors according to a predetermined pattern on one side of the metal substrate, according to exemplary embodiments of the disclosed subject matter. In step 310′, a metal substrate comprising two sides is entirely painted with a color layer, such that side A and side B are colored with a first colored layer. For example, the first colored layer may be white, though any other color may be coated onto sides A and B. In step 320′, primer is applied onto side B only. Primer may be applied onto side B by digital printing, and may be applied according to a predefined pattern. In the example illustrated in FIG. 3B, the pattern according to which the primer is applied onto side B of the metal substrate, is uniform coating on the entire face of side B.

After printing or applying the primer onto side B of the metal substrate, a powder coating is applied onto side B in step 330′. Typically, the powder coating is a UV curable powder coating, which may be sprayed via a powder coating injecting gun, e.g., gun 120. The powder attaches to the metal substrate, thus coating side B in its entirety, and may even coat at least a portion of side A. In the example illustrated in FIGS. 3A-3B, the powder coating may coat side A in a non-uniform manner, e.g., to create a gradient of coated UV curable powder, on one or both ends of side A. The powder coating may comprise a second color, which is different from the color of the first colored layer. In the example illustrated in diagram 300B, the color of the second color is grey, though any other color may be used to color the metal substrate.

In step 340′, the excess of powder coating is removed from all sides of the metal substrate in order to achieve a metal substrate colored with two colors according to a predetermined pattern, which includes uniform coating of an entire face or side of the substrate. Removal of excess of powder coating may be performed by air blowing, e.g., using compressed air blown onto the metal substrate via an air-gun, e.g., air-gun 130. The force of the pressurized air should be stronger than that of the attachment between the powder coating and the metal substrate, while not being stronger than the physical connection between the powder coating and the primer is sticks to. The forced air may thus remove powder from those sections of the metal substrate where no primer is applied, e.g., on side A. Therefore, the powder coating remains all over the entirety of side B only. Following a curing process of the powder coating, a metal substrate entirely painted with at least one color on one of its sides (e.g., side A), while the other side (e.g., side B) is entirely painted with at least one second color, may be formed. In some embodiments, the powder coating may be UV curable powder coating, such that IR and UV curing is required in order to form a stable coating on the metal substrate. IR and UV curing may be performed via IR and UV energy sources, e.g., energy sources 140. In other embodiments other types of powder coatings may be used, e.g., thermal curable powder coatings, in which case curing may be performed via a convection cure oven.

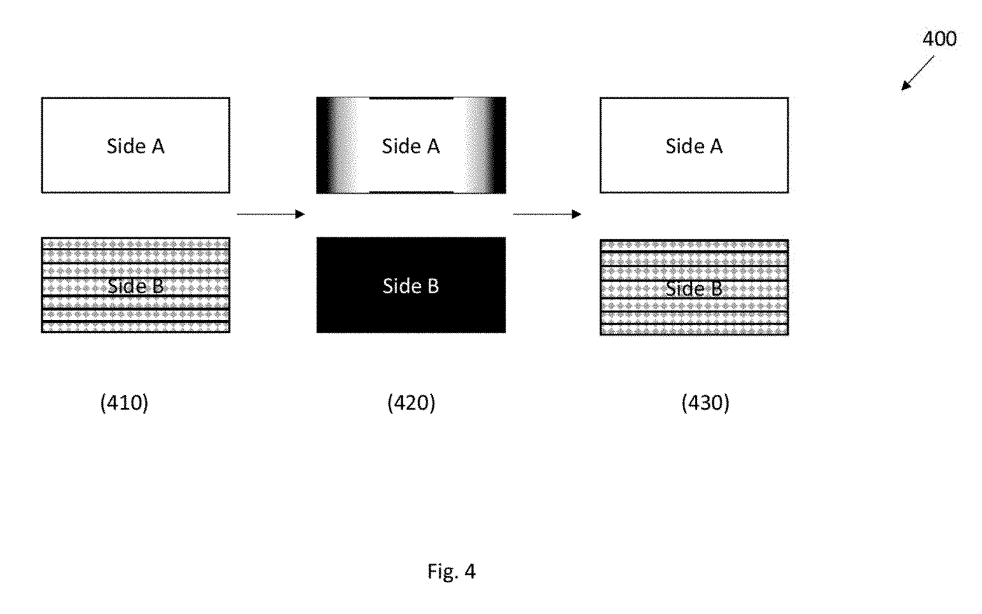

Reference is now made to FIG. 4, which is a schematic diagram 400 illustrating the steps of decorating a metal substrate with at least a third color according to a predetermined pattern on one side of the metal substrate, according to exemplary embodiments of the disclosed subject matter. Diagram 400 may illustrate the steps of applying a second layer of primer according to a second pattern, in order to apply an additional colored layer onto the metal substrate formed in FIG. 3A. Diagram 400 illustrates that there the number of layers of primer that may be applied onto the metal substrate is unlimited, and thus no limit to the number of colored layers that may be applied onto the primer, though each color is to be applied separately following application/printing of the primer according to the predefined multi-colored pattern.

In step 410, primer is printed on side B of the metal substrate, at a particular pattern on top of the ‘squares’ pattern accomplished in step 340. In the example illustrated in step 410, the pattern according to which the primer is printed on side B may be horizontal stripes or horizontal lines. In step 420, a powder coating may be applied onto side B. In the example illustrated in FIG. 4, the color of the powder coating is black, though any other color may be chosen. Typically, the powder coating is applied using a powder coating injecting gun, e.g., injecting gun 120, which sprays the powder onto the metal substrate. Attachment of the powder may be uniform all over the sprayed area, e.g., side B, thus side B may be entirely covered with the powder coating that comprises a third color, which is different from the first and second colors. In some embodiments, the sprayed powder may even reach areas of the metal substrate that are not in direct contact with the sprayed powder, for example, the powder coating comprising a third color, may attach to side A. Thus, efficient removal of excess of the powder coating is performed in step 430, such that powder remains only where it is attached to the primer, according to the pattern defined by the primer, e.g., powder is attached only along the horizontal lines defined by the primer. Removal of excess of powder may be performed using air-blowing, via an air-gun, e.g., air-gun 130, though other methods for removing powder that is not attached onto the primer, may be implemented.

After curing the powder (whether using UV, thermal or any other curing method which corresponds to the type of powder coating), the metal substrate is colored with three colors according to a particular pattern, on at least one side of the metal substrate. Specifically, in the example illustrated in diagram 400, side A of the metal substrate is colored with the first colored layer, while side B is colored with the first colored layer, a second colored layer according to one pattern (e.g., squares), and a third colored layer according to another pattern (e.g., horizontal lines). That is, according to the painting and decorating method and system of the disclosed subject matter, a metal substrate may be colored with more than one color, according to any predefined pattern, on at least one side of the metal substrate, while the other side of the substrate may be colored with at least one color.

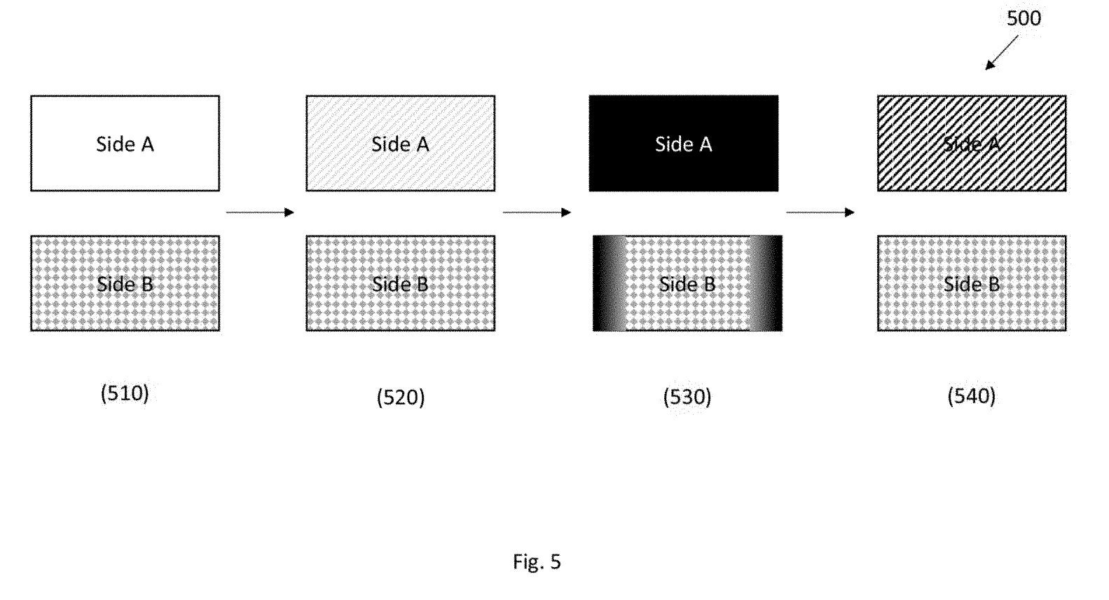

Reference is now made to FIG. 5, which is a schematic diagram 500 illustrating the steps of decorating a metal substrate with at least two colors according to a predetermined pattern on a second side of the metal substrate, according to exemplary embodiments of the disclosed subject matter. A metal substrate may be colored with more than one color according to a predetermined pattern on either or all sides of the metal substrate. In step 510, a metal substrate is colored on one side (side A) with an initially first colored layer, while another side (side B) is colored with at least a second color, which is different from the first color, and which is applied onto the substrate according to a predetermined pattern. In diagram 500, it is side A that is now being colored with a second color.

In step 520, a primer is applied onto side A according to a predefined pattern. The primer may preferably be applied onto the metal substrate by digital printing, which is a precise and relatively quick method for creating a pattern. According to the example illustrated in FIG. 5, the primer is applied on side A in a pattern comprising diagonal lines. Any other pattern may be implemented.

In step 530, side A is painted with powder coating comprising a second color, which is different from the color of the first colored layer, for example, the second color may be black while the first color is white. In other embodiments, any other colors may be used. The powder coating is typically applied via a powder coating injecting gun, e.g., injecting gun 120. An injecting gun may spray the powder coating in an even coat on the entirety of side A (while some of the powder may reach side B as well). In order to form a metal substrate colored according to a predetermined pattern, excess of powder that now coats the entire side A, (and some of side B) needs to be removed.

In step 540, excess of powder that is not attached to the primer according to the predefined pattern, is removed. Removal of excess of powder may be performed by pressurizing air through nozzles of an air gun, e.g., air-gun 130. All excess of the powder not attached to the primer is removed, and the pattern appears in the color of the second colored layer. In the example illustrated in FIG. 5, the pattern created on side A is colored black, though any other color may be used to color side A of the metal substrate.

The result of any of diagrams 300A, 300B, 400 and 500 is a metal substrate comprising at least two sides, wherein each side has a different design, whether the design is based on different color and/or on different pattern. According to the disclosed subject matter, a metal substrate may be colored with at least two colors according to a predetermined pattern, on at least one side of the metal substrate, such that each side of the metal substrate is decorated and colored differently with respect to other sides of the substrate.

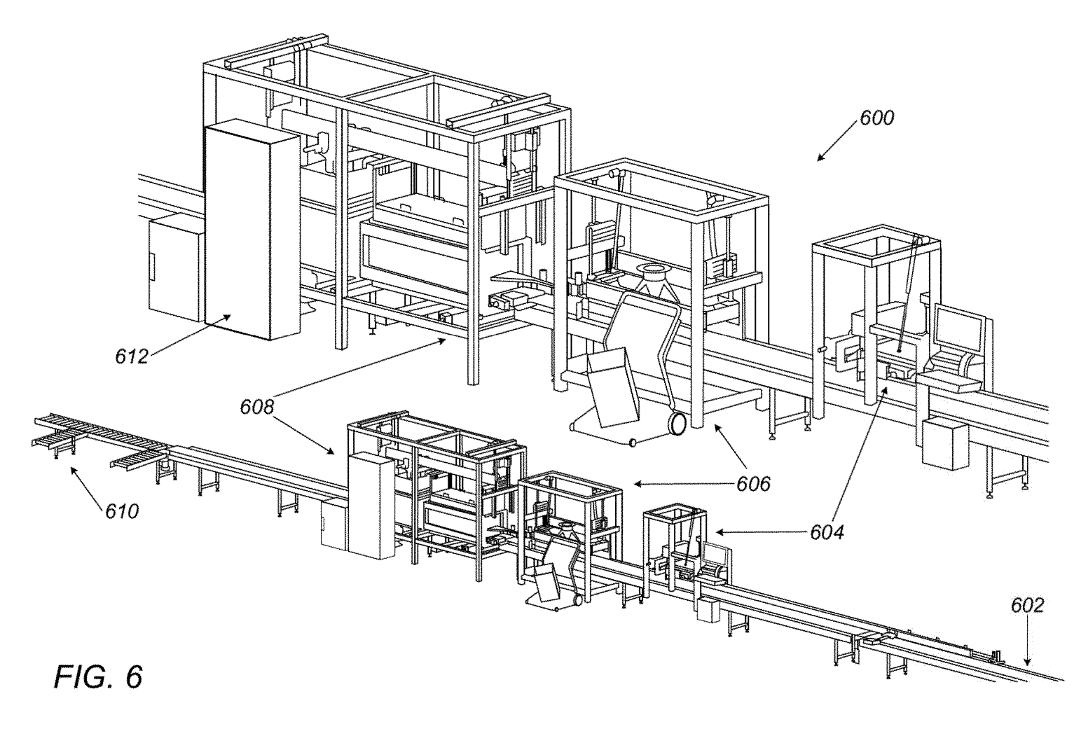

Reference is now made to FIG. 6, which is a schematic illustration of a top-side view of a system for decorating a metal substrate with at least two colors according to a predetermined pattern on at least one side of the metal substrate, according to embodiments of the disclosed subject matter. System 600 may comprise several modules whereby at least some of these modules may be equivalent to the units described in detail with respect to FIG. 1.

In some embodiments, system 600 may comprise an uploading unit 602, typically comprising a conveyer, which may be configured to upload a metal substrate, typically in the form of a metal profile, e.g., aluminum profile, into a printing module 604. Printing module 604 may comprise a printer, typically a digital printer that has been designed for printing primer on various types of profiles. That is, printing module 604 may be an adjustable module that adjusts its parameters and characteristics per the metal profile that is inserted therethrough. Printing module 604 may be equivalent to device 110 for applying primer (FIG. 1).

In some embodiments, system 600 may further comprise a powder coating and air-blowing module 606, which may be configured to apply powder onto the primer that had been printed onto a metal profile by printing module 604, as well as to blow excess of powder off the metal profile in order to ensure that the powder remains only at the location on the metal profile determined by the printed primer, and thus to avoid attachment of powder to areas along the profile which are not supposed to be colored. Module 606 may be equivalent to units 120 and 130 of FIG. 1.

In some embodiments, system 600 may comprise an IR and UV module 608 that may be configured to cure the powder, which may typically be UV curable powder, and thus to cause the powder to attach onto the metal profile, thereby coloring the metal profile according to the predetermined pattern of the printed primer. In some embodiments, module 608 may be equivalent to unit 140 of FIG. 1.

In some embodiments, system 600 may further comprise an off-loading area 610, which may be configured to enable easy and simple off-loading of the colored metal profile from system 600.

According to some embodiments, system 600 may comprise a control and electrical supply units 612, which may be configured to supply power to system 600, as well as control all modules of system 600.

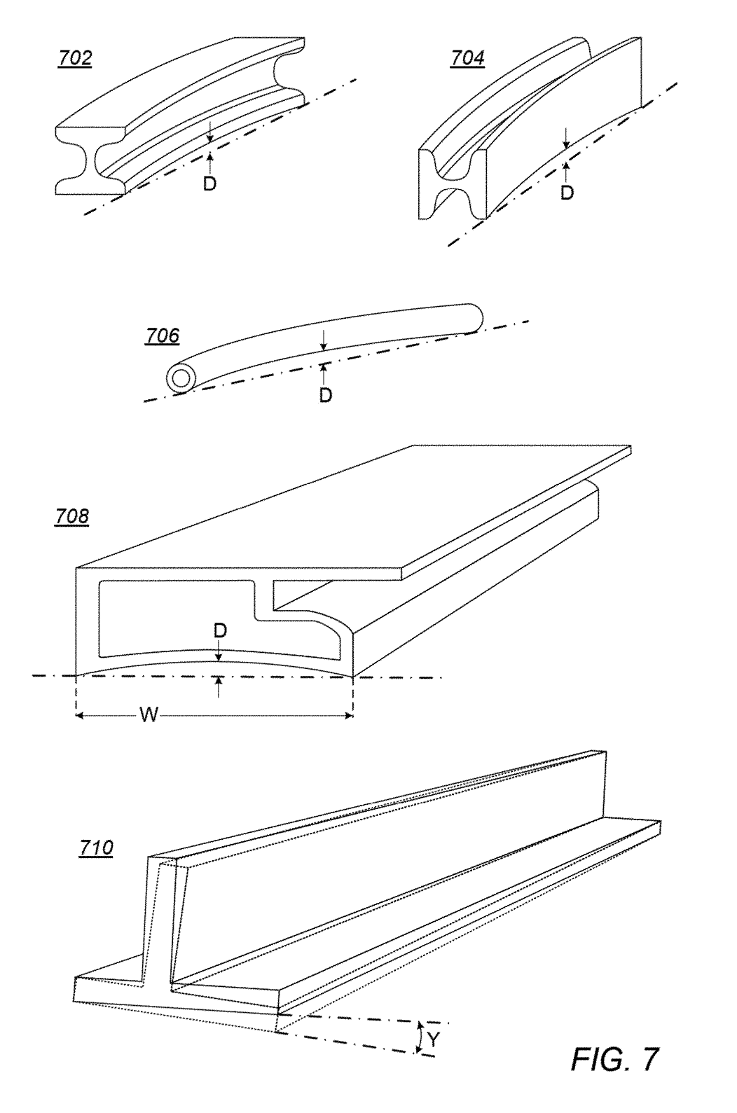

Reference is now made to FIG. 7, which is a schematic illustration of various metal profiles representing the variety of profiles that a system for decorating a metal substrate with at least two colors according to a predetermined pattern is required to color, according to embodiments of the disclosed subject matter. Metal profiles, e.g., aluminum profiles may appear in various shapes and sizes, all of which are should be able to pass through system 600 and exit with a printed pattern thereon. Thus, system 600 and more specifically, printing module 604, is required to adjust itself to the various types of metal profiles. For example, profiles 702, 704, 706, 708 and 710 are examples of metal profiles that may comprise a straight area of between 0.3 mm to approximately 3.5 mm, a cross section width of between 0 to 350 mm, a curvature of the profile surface of between 0 to approximately 2.4 mm, and full length bend of between 0 to approximately 8 degrees, which is typically equivalent to 14% of the cross section of the profile.

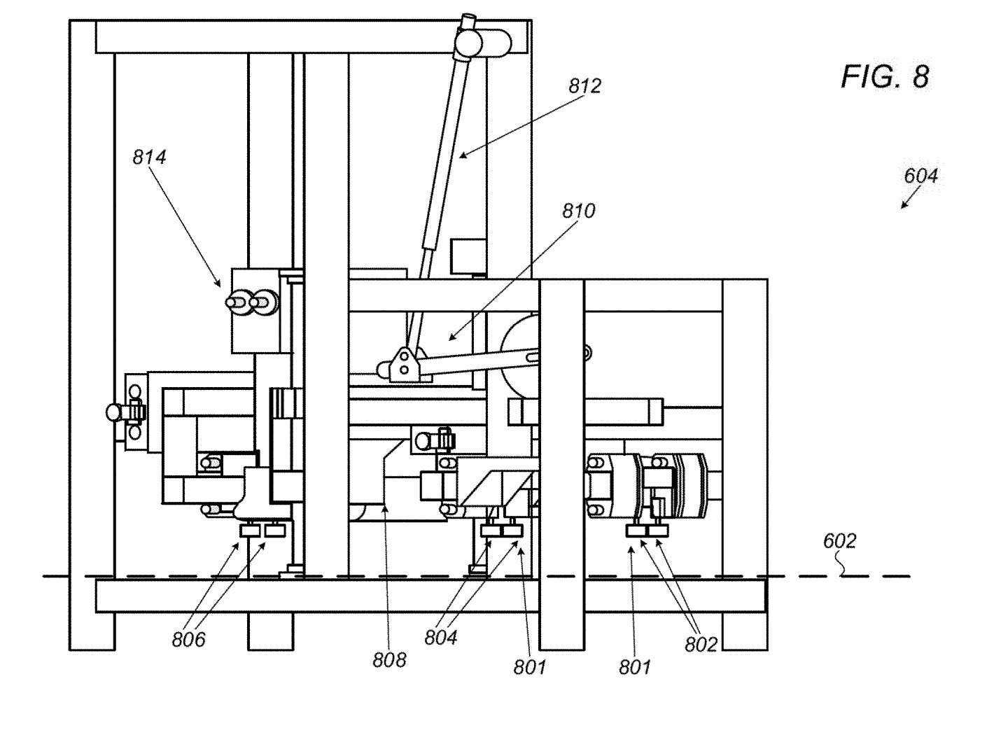

Reference is now made to FIG. 8, which is a schematic illustration of a side view of a printing module that is included in a system for decorating a metal substrate with at least two colors according to a predetermined pattern, according to embodiments of the disclosed subject matter. Printing module 604 may receive a metal profile into it via conveyer 602 (FIG. 6). Printing module 604 may comprise a system 801 for dictating lateral location of the loaded metal profile, in order to ensure that any metal profile is located at a certain predetermined location with respect to printer 814. The location of the metal profile with respect to printer 814 should be at a predetermined location, such to determine printing of the primer is according to the predetermined pattern and at the correct location along the metal profile. Lateral location system 801 may comprise clinching cylinders, e.g., clinching cylinders 802, 804 and 806. Each of the clinching cylinders 802, 804 and 806, typically comprise of two cylinders located on opposite sides of conveyer 602. For example, clinching cylinders 802 may comprise two opposing cylinders that may clinch and hug the metal profile, such that each of the pair of cylinders 802 supports and thus aligns one of the sides of the metal profile that is placed onto conveyer 802. Clinching cylinders 802 may be positioned at the entrance to printing module 604. An additional pair of typically opposing clinching cylinders 804 may be located further along printing module 604, in order to further support and align the metal profile as it continues to move along conveyer 602 towards printer 814.

In some embodiments, printing module 604 may further comprise an additional set of clinching cylinders 806, typically including a pair of cylinders located opposite one another, which may provide support and thus align the metal profile as it exits printing module 604. Since the metal profiles are typically longer than printing module 604, several pairs of clinching cylinders are required in order to ensure that a metal profile is constantly properly aligned with respect to the location of printer 814.

Clinching cylinders 802, 804 and 806 may slightly push any metal profile according to a predetermined position with respect to conveyer 602 and with respect to the location of printer 814, in order to determine that the position of the metal profile conforms to the predetermined pattern that is to be printed thereon by printer 814. That is, according to some embodiments, clinching cylinders 802, 804 and 806 may be able to move parallel to the longitudinal axis of conveyer 602, and parallel to the longitudinal axis of printing module 604.

In some embodiments, the distance between each pair of clinching cylinders should be small in order to be effective during operation of alignment of the metal profile, and yet not too small, in order for alignment to be effective. For example, the distance between each pair of clinching cylinders (e.g., cylinders 802, 804 and 806) may be approximately 400 mm.

According to some embodiments, a first cylinder of any pair of clinching cylinders may be permanent such that is may not be moveable. The position of the first clinching cylinder may be predetermined based on the initial position of printer 814. Accordingly, the second cylinder of any pair of clinching cylinders may be moveable and change, for example via air pressure, such that the position of the second cylinder corresponds to the shape and dimension of the metal profile to ensure the metal profile is clinched and supported between the first cylinder and the second cylinder so it is aligned with respect to location of printer 814. In other embodiments, the first and second cylinders of any pair of clinching cylinders may be moveable to allow alignment of the metal profile with respect to the location of printer 814.

According to some embodiments, printing module 604 may further comprise a height adjustment system 812, which may be configured to adjust the distance between printer 814 and a metal profile that is loaded into printing module 604, with respect to the dimensions, specifically the height, of the metal profile. The distance between printer 814 and the media being printed, i.e., a metal profile, should be between 3 mm to 5 mm. The nominal distance of printer 814 from the metal profile may be adjusted prior to entrance of the metal profile into printing module 604. If the metal profile has a changing height along its longitudinal axis, this would require printer 814 to change its height with respect to the printing module 604, and thus maintain a substantially constant distance between printer 814 and the metal profile. Accordingly, height adjustment system 812 may comprise a tracing or tracking system 808, which may comprise a tracing roller. In cases where the tracing system 808, i.e., the tracing roller is in contact with the metal profile, after adjustment of the nominal distance between printer 814 and the metal profile at entrance of the metal profile into printing module 604, the metal profile may push the tracing roller upwards, which may cause printer 814 to be raised at the same distance equivalent to the distance that the tracing roller was pushed upwards by the metal profile. Therefore, tracing system 808 may be configured to maintain a substantially constant nominal distance between printer 814 and the metal profile such to ensure proper printing.

According to some embodiments, in order to enable raise of printer 814, printing module 604 may comprise a weight balance system 810, which may be configured to provide counter weight against the weight of printer 814. Thus, when tracing system or tracing roller 808 is pushed by a metal profile loaded into printing module 604, the weight balance system 810 enables printer 814 to raise accordingly, by balancing the weight of printer 814.

In some embodiments, in case the metal profile is loaded into printing module 604 such that the shape of the metal profile along its longitudinal axis is convex, then tracing system 808 may easily control the distance between printer 814 and the metal profile, since the convex shape of the metal profile continuously and smoothly pushes the tracing system, at least until the metal profile is loaded into the printing module such that tracing system 808 reaches the peak of the metal profile's concave shape.

In cases where the shape of the metal profile along its longitudinal axis is concave, at the entrance of the metal profile into printing module 604 there might be a sharp pushing force by the edge of the metal profile. Therefore, in order to decrease such an extreme pushing force, tracing system 808 may further comprise some kind of shock absorber, e.g., a spring, which may linger the time to complete the pushing movement caused by the metal profile pushing the tracing system 808. A longer movement may lead to slower accelerations within the system, which may further reduce the forces applied onto printer 814 in order to raise it, thereby avoiding damage to the printing mechanism, which includes injecting drops of color, or in this case drops of primer.

According to some embodiments, before printing module 604 there may be positioned a heating unit, such that the surface of a metal profile that is to undergo printing, is first heated. Heating the surface of the metal profile may improve its surface tension, thus optimizing the primer printing onto it.

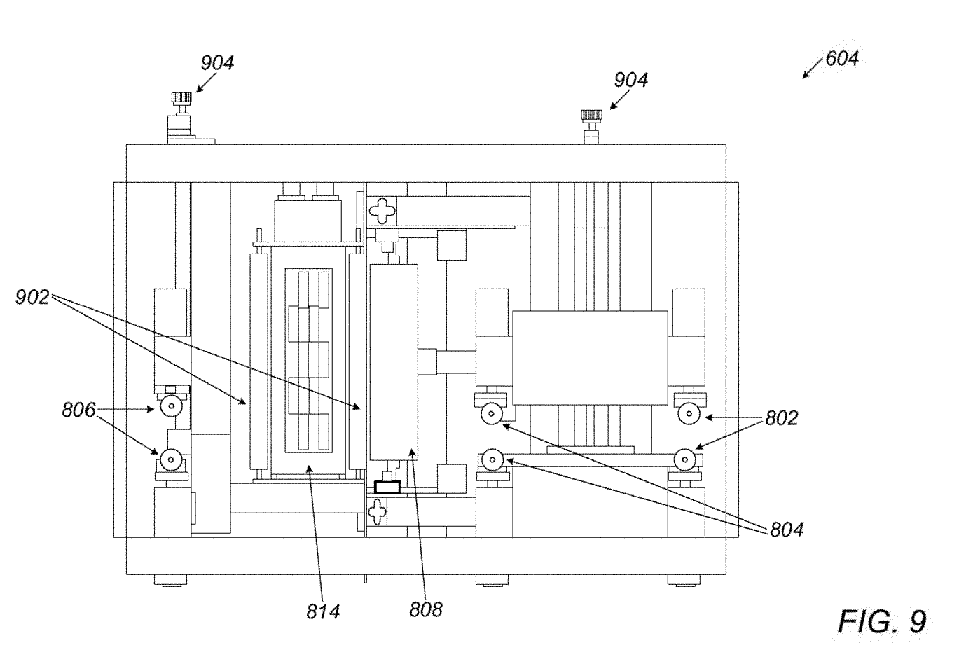

Reference is now made to FIG. 9, which is a schematic illustration of a bottom view of a printing module that is included in a system for decorating a metal substrate with at least two colors according to a predetermined pattern, according to embodiments of the disclosed subject matter. Printing module 604 may comprise clinching cylinders 802, 804 and 806, as described in detail in FIG. 8. According to some embodiments, the clinching cylinders may be controlled via a profile localization system 904. Profile localization system 904 may control the initial permanent location of the first cylinder of a pair of clinching cylinders, which corresponds to the initial location of printer 814. In addition, the movement of the second movable cylinder may be controlled via profile localization system 904. In other embodiments, profile localization system 904 may control movement of each cylinder of any pair of clinching cylinders 802, 804 and 806.

According to some embodiments, printing module 604 may comprise protecting cylinders 902, which may be located adjacent to printer 814. In some embodiments, printing module 604 may comprise two protecting cylinders 902, whereby each of protecting cylinders 902 may be located on an opposite side of printer 814. In other embodiments, other numbers and locations of protecting cylinders 902 may be implemented. Protecting cylinders 902 may be configured to ensure that there is no contact between printer 814 and the printed media, i.e., the metal profile, in order to avoid any damage to the printing mechanism, of printer 814.

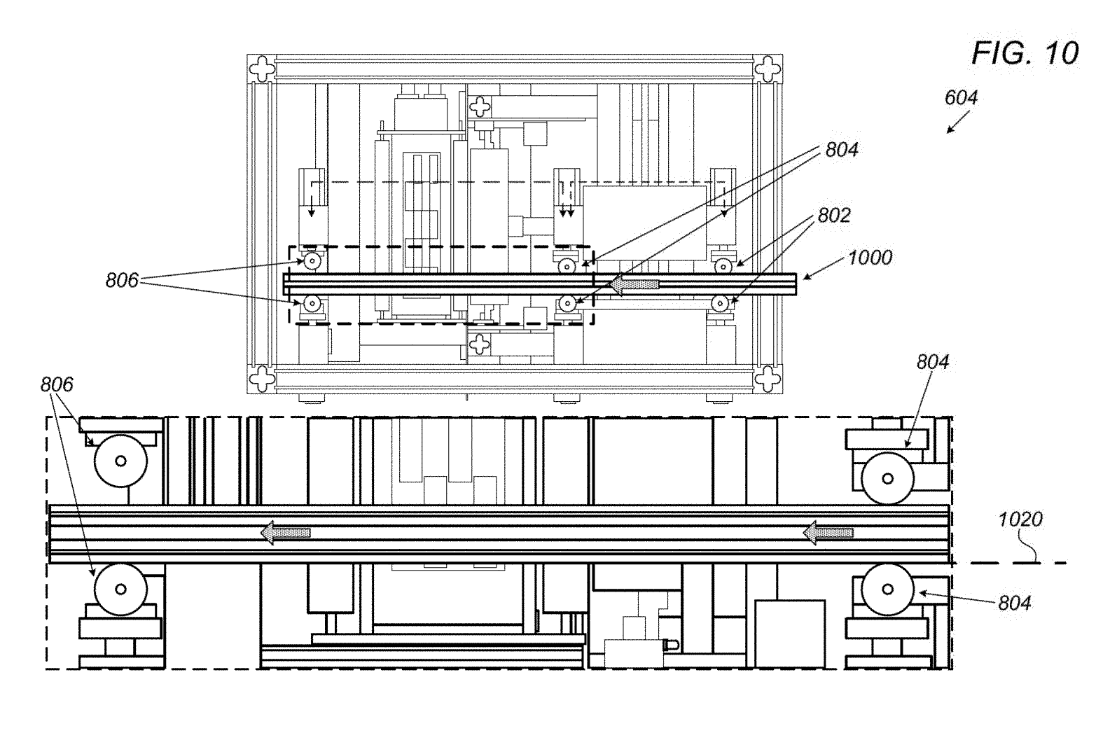

Reference is now made to FIG. 10, which is a bottom view of the printing area of a system for decorating a metal substrate with at least two colors according to a predetermined pattern is required to color, according to embodiments of the disclosed subject matter. FIG. 10 illustrates the “zero” line 1020 of printer 814, which corresponds to the initial location and position of printer 814, according to which location of the first cylinder of any pair of clinching cylinders may be determined.

In some embodiments, profile 1000 may be loaded via conveyer 602 (FIG. 6) into printing module 604, clinching cylinders 802 may be the first pair of cylinders that supports profile 1000 there between, whereas clinching cylinders 804 may be the next cylinders to support profile 1000 as it moves towards printer 814, and clinching cylinders 806 may be the pair of cylinders that support the profile 1000 during its exit from printing module 604, in order to provide further support and alignment of profile 1000 with respect to printer 814. In some embodiments, clinching cylinders 802, 804 and 806 may comprise a non-movable cylinder that may be aligned with respect to line “zero” 1020, which is based on initial location of printer 814. In some embodiments, the movable cylinder of the pairs of cylinders may move with respect to line “zero” 1020.

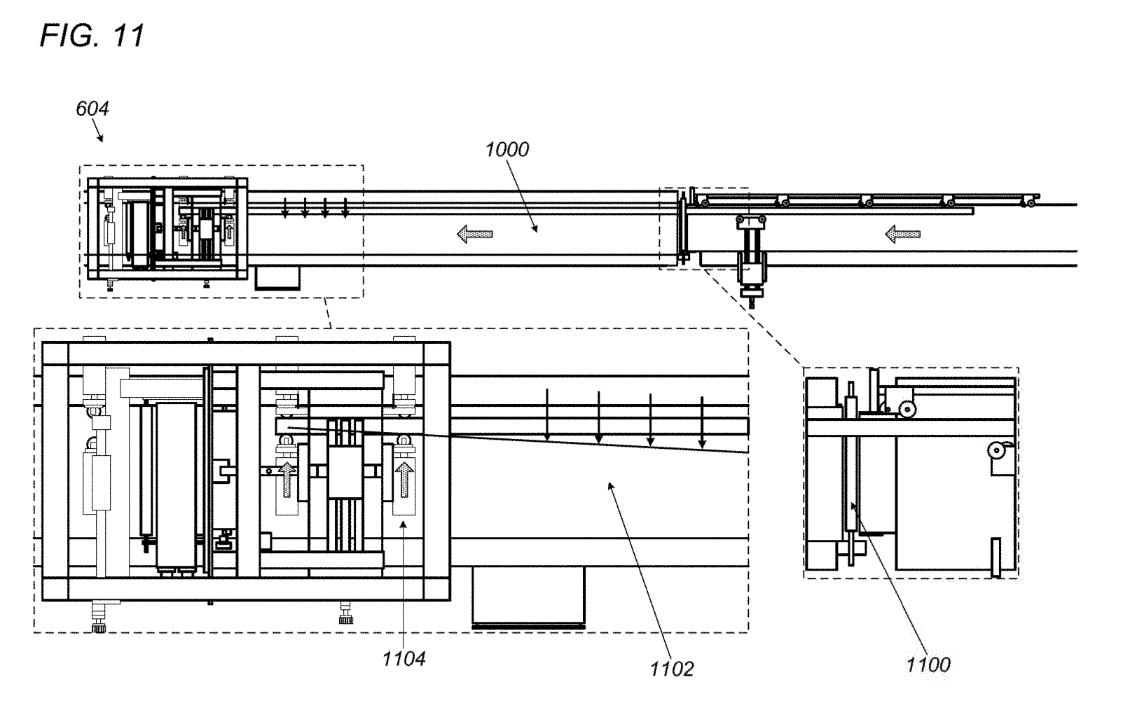

Reference is now made to FIG. 11, which is a top view of a sliding cylinder that is part of a conveyer that pushes metal profiles into the printing module, according to embodiments of the disclosed subject matter. In some embodiments, in order to reduce the forces that are required in order to align extremely long metal profiles, e.g., of lengths between 5 m to 7 m, along the conveyer 602 and with respect to the location and position of printer 814, system 600 (FIG. 6) may comprise a sliding cylinder 1100, which may be located along conveyer 602 prior to the entrance of printing module 604. Sliding cylinder 1100 may slightly elevate the metal profile 1000 such to reduce the friction force 1102 between profile 1000 and conveyer 602, and to reduce the pushing forces applied onto profile 1000 via the clinching cylinders in order to align it with respect to the position of printer 814. In some embodiments, the clinching cylinders may be pushed against profile 1000 using a piston 1104, which may use air pressure in order to operate the clinching cylinders.

In some embodiments, sliding cylinder 1100 may rotate and be elevated such to enable profile 1000 to rise and easily slid into position (with respect to the position of printer 814), with the assistance of clinching cylinders 802, 804 and finally cylinders 806.

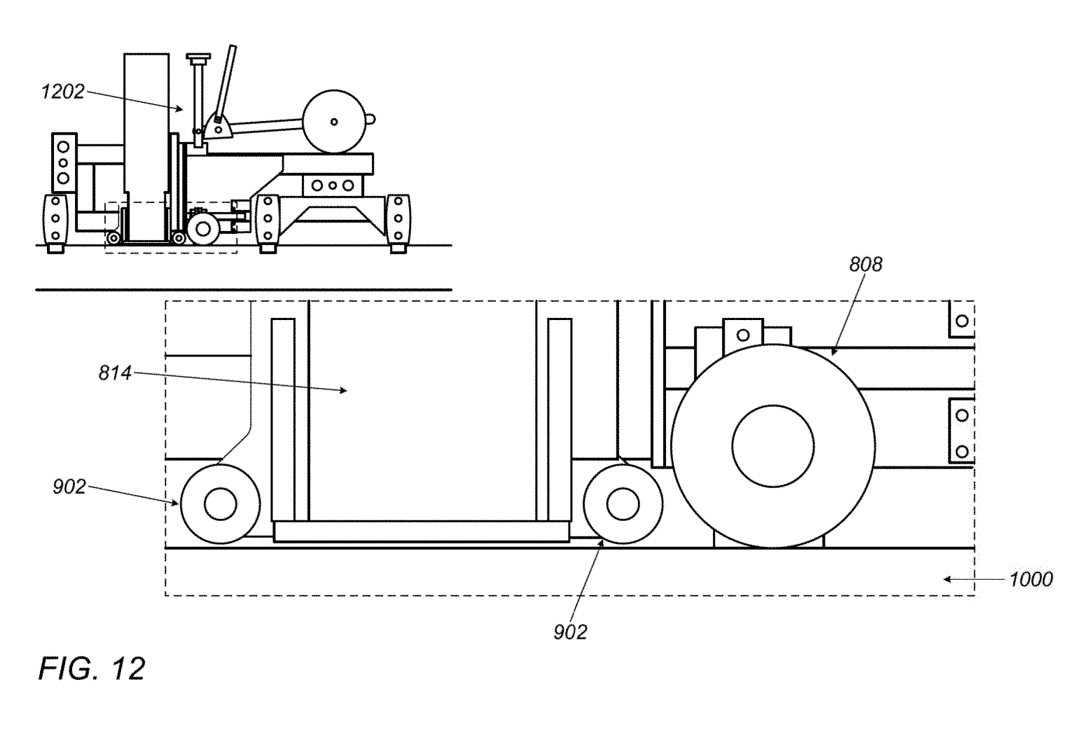

Reference is now made to FIG. 12, which is a side view of a portion of the printing module, according to embodiments of the disclosed subject matter. FIG. 12 illustrates in detail the purpose of tracing cylinder 808 and of protecting cylinders 902. According to some embodiments, tracing cylinder 808 may be located at a distance of approximately 2.5 mm from the proximal end of the metal profile 1000, which is the end that enters printing module first. Printer 814 is typically initially located at a distance of approximately 5 mm from the proximal end of profile 1000. The tracing cylinder 808 dictates the changing height of printer 814 according to the changing height of tracing cylinder 808, such that the distance between printer 814 and profile 1000 would be kept substantially constant during the entire primer printing process. If the tracing cylinder is touched and is thereby pushed by profile 1000, printer 814 is elevated by weight balance system 810, at a length that is equivalent to the length at which tracing cylinder 808 is raised by.

In some embodiments, protecting cylinders 902 may also be at a minimal distance of approximately 2.5 mm from the profile 1000, in order to avoid contact between profile 1000 and printer 814, thereby avoiding damage to be printing mechanism of printer 814.

In some embodiments, printer 814 may be situated on a floating system 1202, which may enable printer 814 to float above profile 1000 and avoid direct contact between printer 814 and profile 1000.

In some embodiments, printer 814 may be configured to print primer according to a predetermined pattern. The pattern may be preloaded onto printer 814 such that printer 814 may print the primer onto a metal profile, e.g., profile 1000, according to the preassigned pattern. In some embodiments, printer 814 may be a digital printer. In some examples, printer 814 may be designed to print along a maximal width of approximately 350 mm, with printing resolution of up to 360[DPI]. In some examples, the printing speed of printer 814 may be up to a maximum of 5 meters per minute, and each drop of primer may be of a size of approximately 37 picoliter [pL]. In other embodiments and examples, other characteristics and other numbers may be implemented.

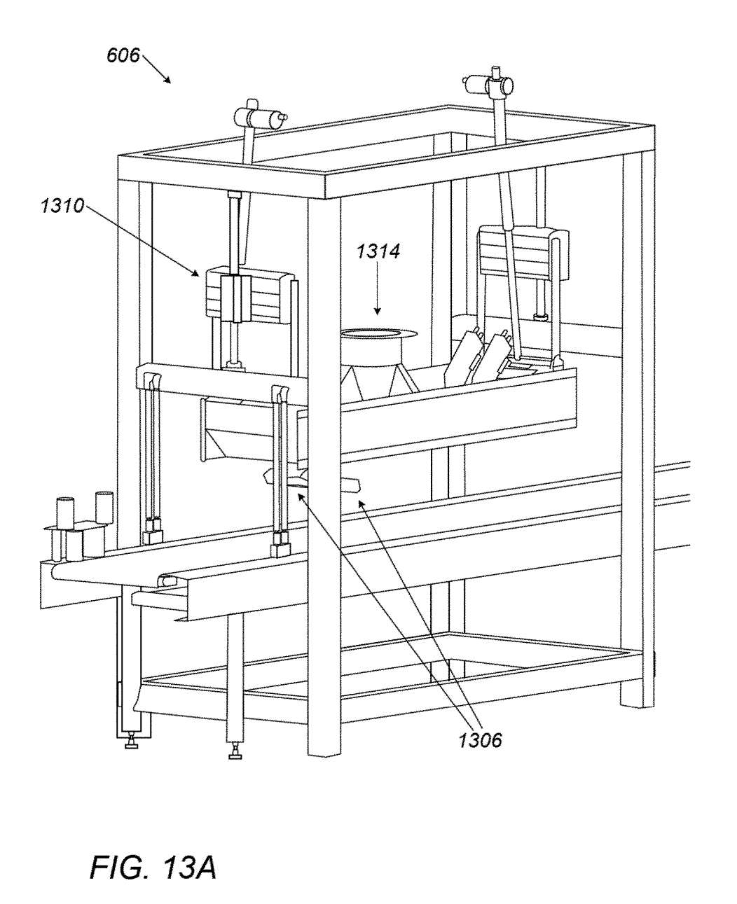

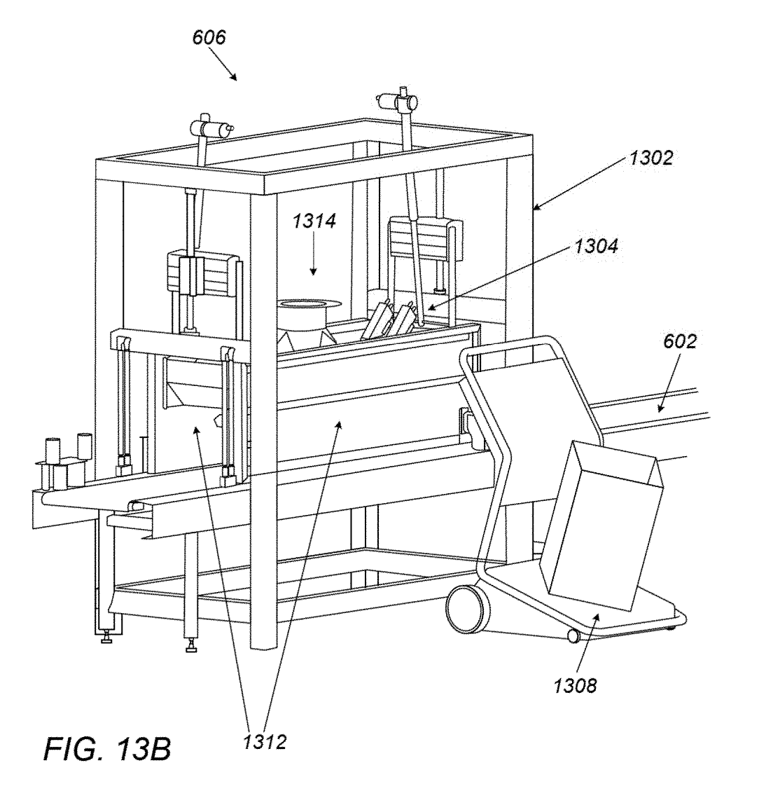

Reference is now made to FIGS. 13A-13B which are schematic illustrations of side-views of a powder coating and air-blowing module, without and with protecting side walls, respectively, according to embodiments of the disclosed subject matter. As illustrated in FIG. 6, system 600 may comprise a powder coating and air blowing module 606, which may be configured to first inject powder onto profile 1000 and then to air-blow excess of powder off profile 1000 such that powder would be attached onto prolife 1000 only at the locations where primer was printed by printer 814.

In some embodiments, powder coating and air blowing module 606 may comprise a static frame 1302, which may encompass the components of module 606. In some embodiments, module 606 may comprise at least one powder coating gun 1304 that is configured to inject powder onto a metal profile that progresses along conveyer 602 and thus through all the modules of system 600. In addition, in order to remove excess of powder off the profile, module 606 may further comprise air blowing units 1306. Air blowing units 1306 may be located either on one side of powder gun 1304, or on both sides of powder gun 1304.

In some embodiments, module 606 may further comprise a suction unit 1308, which may suck the excess of powder that is being removed from the metal profile via air blowing units 1306. Suction unit 1308 may be configured to suck the flowing particles of the blown powder that was not attached onto the metal profile via the printed primer.

In some embodiments, module 606 may comprise a suction opening 1314, which may be configured to suck the excess of powder that is being removed from the metal profile via air blowing units 1306. The location of suction opening 1314 may be above the metal profile, typically between the powder coating gun 1304 and some of the air blowing units 1306. The pressure at which powder is sprayed out of powder coating gun 1304 is higher compared to the suction pressure of suction opening 1314, in order to avoid suction opening 1314 from sucking powder when it exits powder gun 1304 and before it reaches the primer printed onto the metal profile.

According to some embodiments, powder coating and air blowing module 606 may comprise an elevating unit 1310, which may be configured to elevate the powder coating gun 1304 and/or the air blowing units 1306 in order to maintain these units at a predetermined distance from the treated metal profile. As can be seen, FIG. 13B includes protecting walls 1312, which may be included as part of module 606 such to avoid excess of powder flowing randomly in the air along system 600. FIG. 13A does not include protecting walls 1312 in order to enable a better view of the components of module 606 that may be covered by protecting walls 1312.

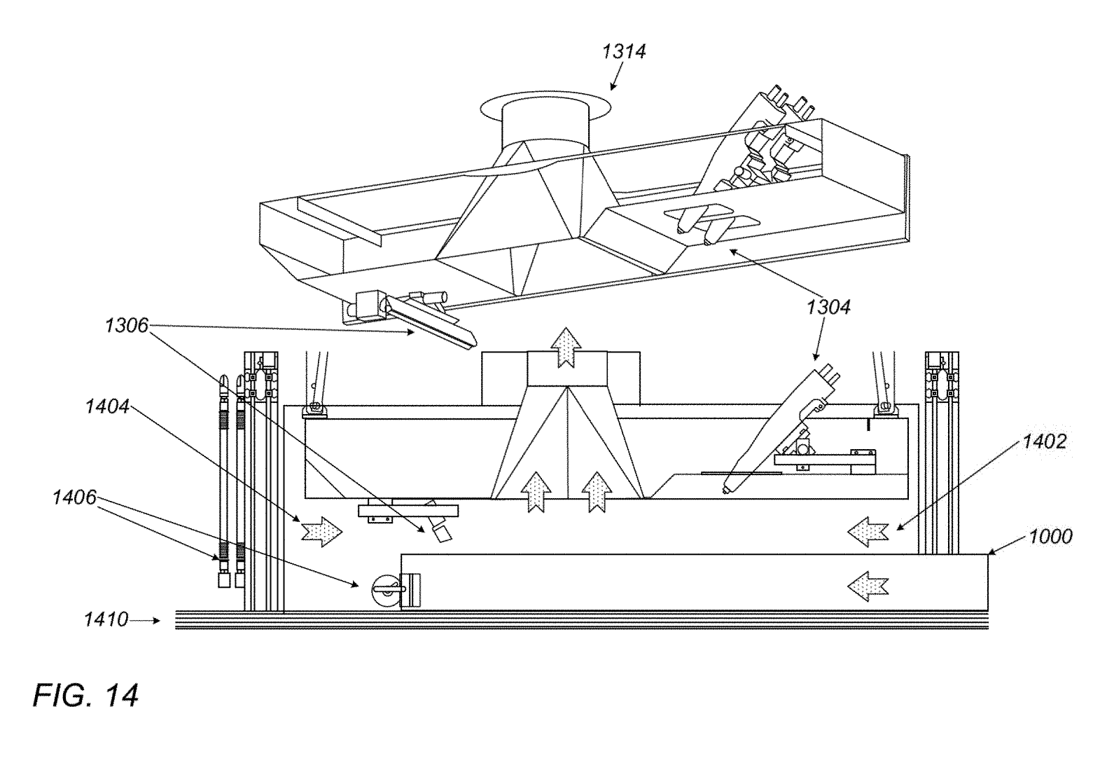

Reference is now made to FIG. 14, which is a schematic illustration of a side view of a powder coating and air-blowing module, according to embodiments of the disclosed subject matter. At least one powder coating gun 1304 may be configured to spray a powder coating at a second color that is different from the first color at which substantially the entirety of the metal profile is colored. The color of the powder is typically different from the total color of the metal profile in order for the pattern according to which primer was printed onto the metal profile, and according to which the powder coating is applied onto the metal profile, would be visible compared to the first color substantially coating the entirety of the metal profile prior to primer printing.

The angle at which the at least one powder coating gun 1304 is positioned at within module 606 and the distance between powder gun 1304 and the metal profile may be adjusted according to the shape of the metal profile, or according to characteristics of the powder and primer, e.g., affinity between the primer and the powder.

According to some embodiments, module 606 may further comprise air blowing units 1306, which may be configured to blow excess of powder off the metal profile, so that only where primer is printed would the second colored powder stay attached, and in areas lacking of primer, such powder would be removed, in order to ensure the powder would be attached only according to the predetermined and desired pattern.

Air blowing units 1306 may be located at various locations along module 606, e.g., at the proximal end of the profile, following spraying of the powder onto profile 1000 that may be carried by conveyer 1410. Other locations and angles of positioning may be adjusted according to the shape of metal profile being painted, and the location of slots along the metal profile.

In some embodiments, air may be allowed or even encouraged to enter into module 606 in order to facilitate air movement within module 606. Air movement within module 606 may assist with the air blowing process of removing excess of powder off the metal profile. Air may enter module 606 from the distal side of module 606, e.g., side 1402, and from the proximal side of module 606, e.g., from side 1404.

According to some embodiments, module 606 may comprise additional air blowing units at the sides of the metal profile, e.g., side-air-blowing units 1406, which may be configured to assist the main air blowing units 1306 in removing excess powder off the metal profile. The location and position, e.g., angle of position may be adjustable in accordance with the shape of the metal profile being handled, and the location of slots along the metal profile.

In some embodiments, module 606 may comprise a suction opening 1314 through which excess of powder may be removed from module 606. That is, powder that did not attach onto the printed primer, or which had been blown off the metal profile as being sprayed onto locations lacking of primer, may be sucked via suction opening 1314. Suction opening 1314 may be typically located above the metal profile between the at least one powder coating gun 1304 and the air blowing units 1306.

In some embodiments, the air blowing units 1316 and/or 1406 may also dean and clear the conveyer, e.g., conveyer 1410, by blowing the powder coating off it, while blowing the excess of powder off the metal profile.

In some embodiments, conveyer 1410 may be configured to be in the form of a closed loop such to that conveyer 1410 may rotate around the same loop over and over again. Conveyer 1410 may carry a metal profile, e.g., metal profile 1000, during the powder and air blowing process along module 606, and then be directed beneath powder coating and air blowing module 606 such to return back up adjacently to the opening of module 606, and so on, thereby creating the closed loop form. In some embodiments, a conveyer cleaning system may be located beneath conveyer 1410, e.g., at a location corresponding to conveyer 1410 being directed beneath module 606 and before conveyer 1410 returns back up next to the opening of module 606. A conveyer cleaning system may comprise, for example, air blowing units, which may blow powder off conveyer 1410 in order to dean conveyer 1410 from excess of powder after conveyer 1410 finished to carry one metal profile through module 606 and before conveyer 1410 carries a new metal profile through module 606. Cleaning conveyer 1410 may avoid powder from contacting the bottom portion of a new metal profile that may be loaded onto conveyer 1410, and thus avoid coloring the new metal profile not according to the predetermined pattern.

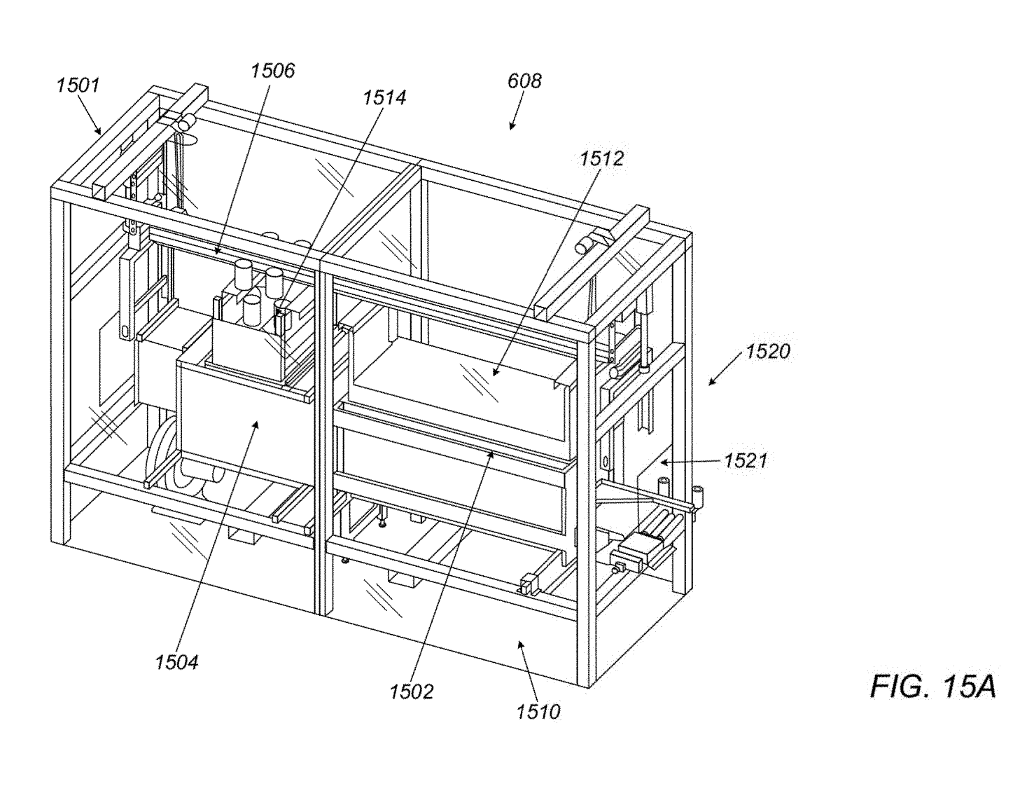

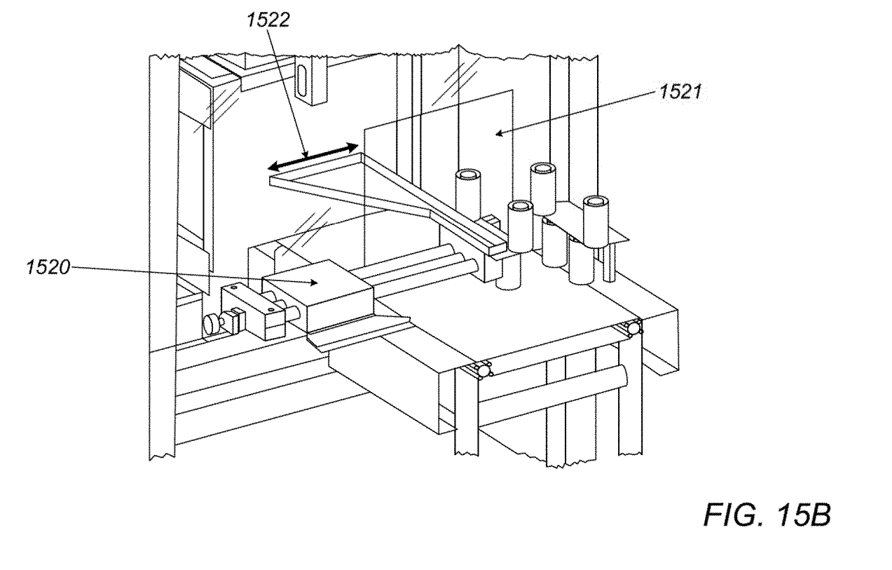

Reference is now made to FIGS. 15A-15B, which are schematic illustrations of a respective top-side view of an IR and UV module, and of a respective side view of a securing opening and closing mechanism located at the entrance of the IR and UV module, respectively, according to embodiments of the disclosed subject matter.

As may be seen in FIG. 15A, IR and UV module 608 may comprise an IR unit 1502 and a UV unit 1504, enclosed within one or more static frame 1501. In some embodiments, IR unit 1502 may comprise an adjustable IR frame 1512, and UV unit 1504 may comprise a separate adjustable UV frame 1514. According to some embodiments, the position of each of IR unit 1502 and of UV unit 1504 may be adjusted via each of the corresponding adjustable frames 1512 and 1514, respectively, according to the optimal distance of each of the IR energy source 1502 and the UV energy source 1504 from a metal profile, in order to maximize the efficacy of operation of each of the IR and UV energy sources 1502 and 1504, respectively.

In addition, once the optimal location of each of IR unit 1502 and UV unit 1504 is determined via adjustable IR frame 1512 and adjustable UV frame 1514, the distance of IR unit 1502 and of UV unit 1504 from a specific metal profile may be adjusted via raising beam 1506, which may raise IR unit 1502 and UV unit 1504 at a required distance from the metal profile, while maintaining the adjusted location of each of these units via their adjustable frames 1512 and 1514. That is, raising beam 1506, may raise units 1502 and 1504 together, once the relative location of each of these units is determined by their respective adjustable frames 1512 and 1514, according to the optimal operation distance from a metal profile. Once the relative location between the two units 1502 and 1504 is determined and adjusted via their corresponding adjustable frames 1512 and 1514 per their optimal operation distance, units 1502 and 1504 may be raised or lowered simultaneously as one single unit away or towards the optimal and safe distance from any type of metal profile that is inserted into IR and UV module 608. For example, if the metal profile inserted into module 608 is of a large width, raising beam 1506 may simultaneously raise IR unit 1502 and UV unit 1504 as one unit, in order to distant both of these units (while maintaining their adjusted relative location) away from the metal profile up to the proper operation and safety distance. However, if the metal profile inserted into module 608 is of a small width, and the IR unit 1502 and UV unit 1504 are too far from the metal profile, raising beam 1506 may simultaneously lower these two units (while maintaining their adjusted relative location) closer to the metal profile until the optimal operation distance is reached.

In some embodiments, IR and UV module 608 may comprise covers 1510, which may isolate module 608 from the external environment. This is important since an extremely hot environment is necessary in IR unit 1502, and heat should be maintained within unit 1502 such to reach the required high temperatures, without any heat escaping from IR unit 1502. For example, the temperature within IR unit 1502 may reach 170 degrees Celsius, with a deviation of ±10 degrees Celsius. Since the typical time that a metal profile stays within IR section is approximately 5-10 seconds, which is very short, avoiding heat escape is an even more crucial aspect. As illustrated in FIGS. 15A-15B, in addition to covers 1510, module 608 may further comprise an entrance adjusting system 1520 that may be configured to adjust opening and closing of the entrance 1521 to module 608. In order to avoid escape of heat from IR unit 1502, the entrance 1521 of module 608 may comprise entrance system 1520, which may be configured such that its closed state is its rest state. That is, system 1520 maintains the entrance 1521 of module 608 closed, unless a new metal profile pushes against the entrance 1521 in order to enter module 608. Entrance system 1520 may move along the directions illustrated by arrow 1522. Entrance system 1520 may be positioned such to close entrance 1521 by default, unless a metal profile is pushed against entrance system 1520 by the conveyer, which would cause entrance system 1520 to move such to open entrance 1521 and allow the metal profile to pass therethrough.

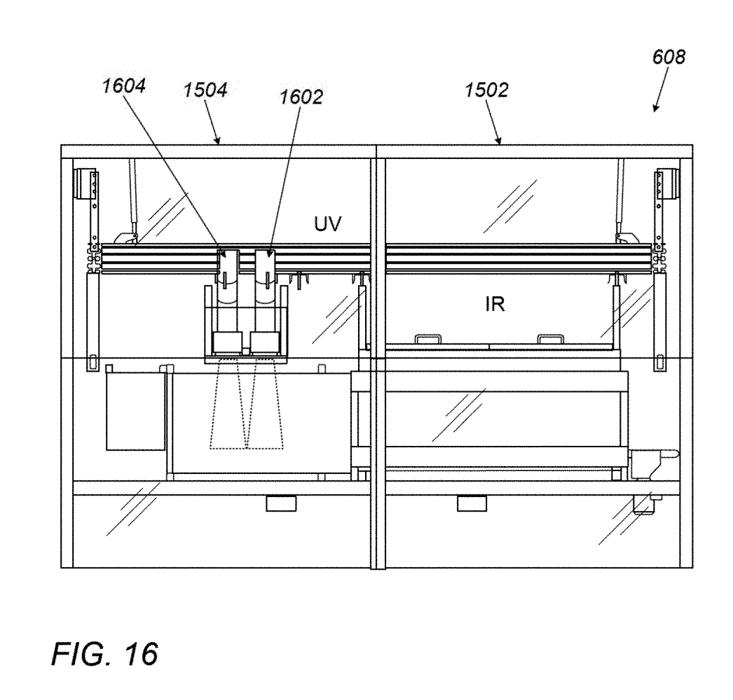

Reference is now made to FIG. 16, which is a schematic illustration of a side view of IR and UV module, according to embodiments of the disclosed subject matter. IR and UV module 608 may comprise two separate sections, IR unit 1502 for applying IR radiation and thus causing the coated powder to liquidize, and a UV unit 1504 for UV curing for causing the coated powder to solidify and cross-link with the printed primer and strongly attach to the metal profile. In some embodiments, UV unit 1504 may comprise at least one UV lamp, though in some embodiments, UV unit 1504 may comprise two UV lamps, which may illuminate at different wavelengths. For example, a first UV illumination source 1602 may illuminate at a wavelength of 420 nm, while a second UV illumination source may illuminate at a wavelength of 360 nm. It is clear that any other UV illumination source configured to illuminate at other wavelengths may be used, according to the type of powder coated onto the metal profile, and the type of primer printed onto the metal profile.

In some embodiments, the IR unit 1502 may comprise an IR illumination source irradiating at a wavelength approximately between 2000 nm to 4000 nm. The temperature

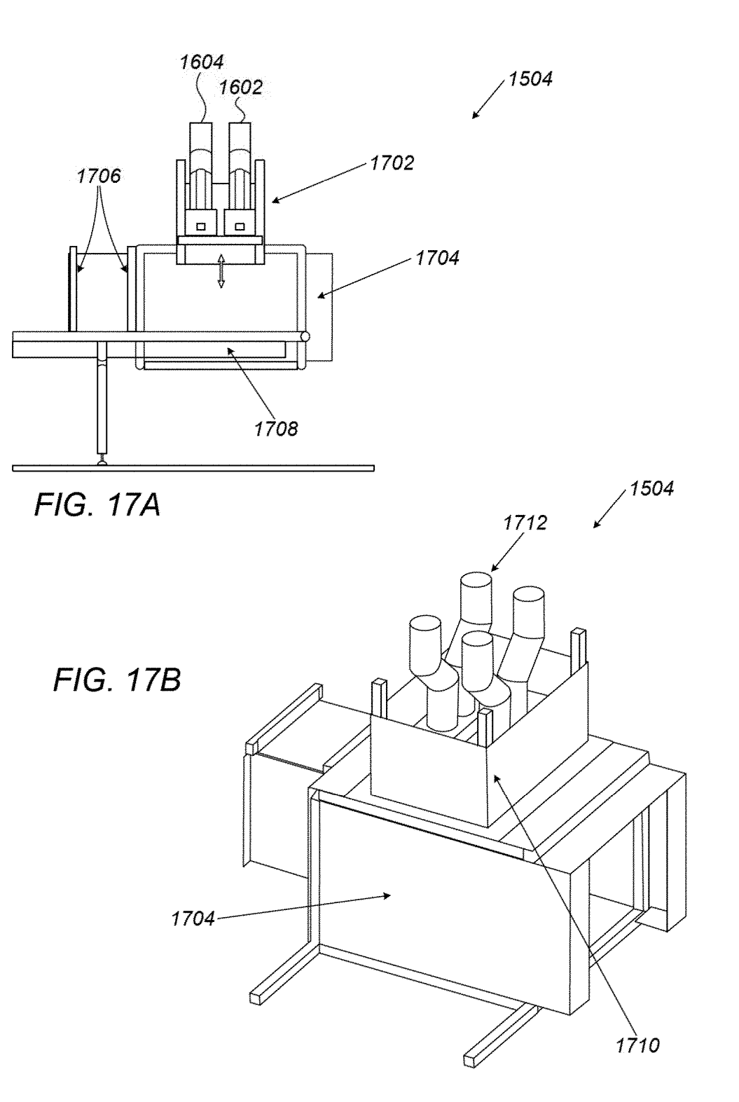

Reference is now made to FIGS. 17A-17B, which are schematic illustrations of a side view and a respective side view of a UV unit, respectively, according to embodiments of the disclosed subject matter. According to FIG. 17A, UV unit 1504 may comprise two UV illumination sources 1602, and 1604. Other numbers of UV illumination sources may be implemented within UV unit 1504. UV unit 1504 may further comprise a conveyer 708 which is configured to carry the metal profile, which was already irradiated with IR in IR unit 1502.

In some embodiments, UV unit 1504 may further comprise a fixed protecting cell 1704, which may protect a user standing outside UV unit 1504 from being exposed to UV light. In some embodiments, UV unit 1504 may comprise a rising UV frame 1702, which may be configured to raise UV illumination sources 1602 and 1604 to the appropriate distance from the metal profile carried by conveyer 1708.

In some embodiments, UV unit 1504 may comprise brushes 1706, which may prevent UV light from exiting outside of UV unit 1504. Brushes 1706 may be located at a distance from one another; one may be located at the exit of UV unit 1504, while another one may be located farther along conveyer 1708 in order to protect a user standing outside IR and UV module 608 from exposure to UV light. The brushes 1706 may prevent UV light from passing therethrough.

According to FIG. 17B, UV unit 1504 may comprise a cooling unit 1712. Cooling unit 1712 is configured to cool the metal profile while entering into UV unit 1504, since UV illumination sources are sensitive to heat. Thus after the metal profile is heated by the IR unit 1502 to very high temperatures, it is then cooled by cooling unit 1712 such to enable proper operation of UV illumination sources 1602 and 1604.

In some embodiments, UV unit 1504 may comprise a service opening 1710 through which a user may have access to fix or attend any problem that may occur to UV unit 1504.

In some embodiments, following exit of the metal profile from IR and UV module 608, the metal profile may be offloaded from system 600 (e.g., at area 610, FIG. 6) and may be moved to storage and/or packaging.

At the end of system 600, metal profiles are typically of one major background color, which is colored all over the metal profile, along with a decoration at a color typically different from the background color, which was applied according to a predetermined pattern. Any pattern may be printed onto the metal profiles via the printed primer in printing module 604, and any color may be applied onto the primer via powder coating and air blowing module 606. IR and UV module 608 ensure that the coated color is strongly attached to the primer and onto the metal profile, thus providing a long lasting patterned decoration onto substantially any shape and size of metal profile.

In some cases, UV (Ultraviolet) curable powder coatings may be limited in the range of colors possible for use. Implementing a system that incorporates use of such UV curable powder coatings requires special manufacture of such type of colors. In addition, an adjustment of UV and IR energy is required per wavelength of each color of paint. These limitations lead to high complexity of the system. Furthermore, decorations that have a certain thickness above the surface of the metal substrate, i.e., 3D decorations, require high precision when applying primer onto which colored powder is applied, and further requires to precisely remove all excess of powder prior to the curing process. Thus, there may be a need for a system and method that may enable precise and high quality 3D decorations applied onto a metal substrate, which may implement thermal curing and a sufficient system for removing excess of powder that is not attached to the primer.

Digital printing enables accurate printing of any particular pattern and shape in accordance to a predefined digital-based image, while avoiding the costly need to manufacture a mask, stamp or printing plate per each pattern or shape that is to be applied onto an object. Therefore, printing a primer using a digital printer according to a predetermined drop size may enable printing the primer at a precise predefined pattern or shape, at a certain thickness above the surface of a metal object, onto a side or a face of the metal object (which in some cases may have already been colored with a first color or may have undergone anodization), in order to create a metal object decorated with a 3D decoration, in accordance with a predetermined pattern. The primer should be configured to enable such precise printing. Thus, the primer should be designed to have specific viscosity and stickiness characteristics that would enable precise application of the primer onto the metal object via a digital printing device, as well as control on the degree of thickness above the surface of the metal object. The primer should have precise viscosity such to be applied accurately by the printing device according to the predetermined pattern, i.e., the primer should have low viscosity in order to enable the primer to continuously and uniformly flow through the nozzles of the printing device, while enabling application of precise pattern for the 3D decoration.

Following printing of the primer at a desired pattern or shape, and at a certain drop size onto the side or face of the metal object, electrostatic thermal curing powder coating comprising color may be sprayed onto the printed side of the object. Powder coating spreads uniformly onto the printed side of the sprayed metal object, thus excess of the powder that is not attached to the primer is required to be removed. Typically, removal of excess of powder may be performed using air blowing. However, in some cases, air blowing is not sufficient enough and there is a need for an additional system for removing excess of powder, while maintaining powder only at the locations dictated by the predetermined pattern. Thus, this disclosure teaches use of a brushing system, which has specific characteristics for removing excess of powder, without causing any damage to the predetermined pattern of primer. That is, the brushing system, which may comprise one or more brushing units, is designed to remove excess of powder while not smearing the primer printed onto the metal object. Finally, the printed side of the metal object is exposed to thermal heat, which cures the electrostatic thermal curing powder coating according to the predefined pattern at which the primer was printed onto the metal object. A metal object decorated with 3D decorations according to a particular pattern is then formed.

According to one example, the pattern according to which the primer is applied onto the metal object may include the entire area of one side or face of the metal object. According to such example, the metal object which may be entirely painted with a first color initially painted onto the metal object or which may be entirely anodized, may comprise one side or face that is entirely painted with a second color of the electrostatic thermal curing powder with any predetermined drop size, while the other sides or faces of the metal object may not be 3D decorated with paint of a second color at all. In such example, the pattern may include an entire face or side of the metal object being covered with paint at a certain thickness. According to other examples, the pattern may include any kind of visual ornament or decoration that may show the second color of the electrostatic thermal curing powder as well as the first color initially painted onto the metal object or the anodized process that the metal object went through prior to the 3D decoration. In some embodiments, the second color may be the same as or different from the first color. The pattern may include more than one color, such that a primer may be printed and electrostatic thermal curing powder coating may be applied a plurality of times, as required to accomplish a multi-colored pattern.

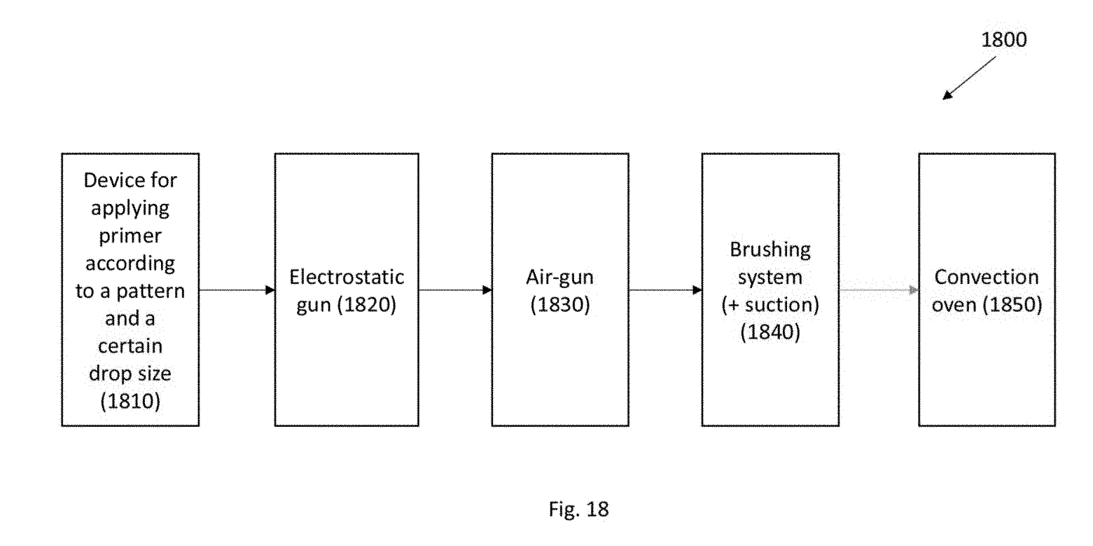

Reference is now made to FIG. 18, which is a schematic diagram of a system 1800 for decorating a metal substrate with 3D decorations according to a predetermined pattern on at least one side of the metal substrate, according to embodiments of the disclosure. According to some embodiments, the metal substrate may be made of any metal or alloy, for example, aluminum, iron, copper, steel and/or stainless steel. Any other metal may also be decorated with 3D decorations according to the disclosure. In some embodiments, the metal substrate is initially painted with a thermal curable powder coating comprising a first color. The powder coating is sprayed onto the metal object via a powder gun, e.g., an electrostatic powder gun, such that the powder is attracted to the metal object and creates a uniform coating over the metal object. In other embodiments, the metal object may be painted with a first color via other methods of painting, e.g., anodizing coating process.

According to some embodiments, system 1800 may comprise a device 1810 for applying a primer onto a metal substrate or metal object. Device 1810 may be configured to apply the primer onto the metal object according to a predefined or predetermined pattern and according to a certain drop size. The pattern may dictate the areas of the metal object onto which an electrostatic thermal curing powder coating should be implemented, i.e., the type of decorations, while the drop size may dictate the degree of protrusion of the coating above the surface of the metal object, i.e. the presence and grade of 3D decorations.

According to some embodiments, the predefined pattern may be selected by any person whom the painting and 3D decorating of the metal object is for. The predetermined pattern according to which the primer is applied onto the metal object may be any kind of visual ornament or decoration, and in some embodiments may include a uniform covering of one side or face of the metal substrate. Typically, a digital file of the predetermined pattern is prepared, such that primer may be applied onto the metal object accordingly.

In some embodiments, the drop size may dictate the degree of thickness of the primer and thus of the degree of thickness of the decorations applied onto the metal object. The drop size may be selected, for example, between 1 dpd [drop per dot] to 7 dpd, though other ranges may be implemented. 1 dpd generates the smallest drop size of the range, while as the number rises, the drop size and thus thickness of the 3D decorations is of a higher degree. It should be noted that when determining drop size, one should take into consideration the type of pattern. For example, the larger the drop size, the less accurate a pattern may turn out, since large amount of primer may be equivalent to, for example, thicker lines along a pattern. Thus, there should be correlation between pattern characteristics and selected primer drop size.

Preferably, device 1810 may be a digital printer for digitally printing the primer according to a predetermined digital-based image. Digital printers that may be used to accomplish printing of a primer may be inkijet type printers, e.g., digital inkjet printers manufactured by Xerox, Fuji, Konica Minolta, Kyocera, etc. Such digital printers are required to be adjusted to printing primer instead of ink. For example, clogging of the nozzles of such printers may occur due to remains of dry primer. Primer may dry within the nozzles of the printers if primer is not continuously flowing through the nozzles, which may be the case when conforming the exit of the primer from certain nozzles to the predefined pattern of the digital-based image. In order to overcome such clogging of the nozzles of a digital printer, predetermined time periods for cleaning the nozzles of the printing system may be defined. The time periods at which cleaning of the printing system may take place, may be determined by the typical time it takes the primer to dry. Furthermore, implementing a thermal control unit in the printing system may assist in controlling the viscosity of the primer, thereby preventing it from drying and clogging the nozzles of the printing system.

In some embodiments, the pattern according to which the primer is applied, further defines the final pattern of the color that is to be applied onto the primer. In some embodiments, the final pattern may be of a second color, which may be the same as or different from the first color that may be initially applied onto the metal substrate.

In some embodiments, the primer that is applied onto the metal substrate may be any type of UV based primer, solvent based primer or thermal based primer. As explained above, a thermal based primer may be a primer that changes its state from fluid (which is the state in which the primer is applied onto the metal substrate) to “sticky” (which is the state that enables other materials to adhere to it, e.g., the powder coating, as described hereinafter) only after being thermally heated, e.g., while and after passing through a convection oven. A solvent based primer may be a primer that changes its state from fluid to sticky following evaporation of the solvent. A UV based primer may be a primer that changes its state from fluid to sticky after being positioned under a UV energy source.

Since the sticky state of the primer is the state required for adhesion of a powder coating to the primer, it is beneficial to have the primer reach its sticky state soon after the primer is applied onto the metal substrate. This also ensures that the surface of the metal substrate that is now applied with primer, is smooth and aesthetic. When using a UV based primer, one method of accomplishing the primer reaching its sticky state soon after it is applied onto the metal substrate, includes verifying that an intensity of the UV energy activating the primer is sufficiently high, e.g., above a predetermined threshold. When using a thermal based primer, one method of accomplishing the primer reaching its sticky state soon after it is applied onto the metal substrate comprises ensuring that the temperature in the convection oven is sufficiently high, e.g., above a predetermined threshold.

On the other hand, the time till the second color (e.g., powder coating comprising the second color, as described hereinafter) is applied onto the primer is required to be soon after the primer has become sticky, in order to avoid a scenario of applying the second color onto a dry primer, which will not result with proper adhesion of the second color to the primer.

In some embodiments, system 1800 may further comprise a powder coating gun 1820. Powder gun 1820 may be configured to spray a powder coating comprising a second color, onto the primer. In some embodiments, powder gun 120 may be an electrostatic gun, which may be configured to spray the powder coating comprising the second color onto the primer, while charging the powder with positive electrical charge.

Preferably, the electrostatic powder coating may be a thermal curing powder coating type, in order to enable working with almost any tone of color provided from off-the-shelf electrostatic thermal curing powder coatings. Whereas, UV curable powder coating is significantly limited in the range of available colors and require adjustment of UV intensity per color. However, in other embodiments, the powder coating may be a UV curable powder coating or any other type of powder coating.

Some examples for powder coatings that may be applied onto the primer are polyester, polyester dry blend, superdurable resin, polyurethane, polyester, and acrylics. Powder coatings such as the ones mentioned, as well as others, may differ from one another in their durability to impact, to humidity, and to oxidization, and in their level of gloss, among other characteristics. Thus, the surface tension of each of the powder coatings is different, and should be taken into consideration with respect to the level of surface tension of the primer when applied onto the metal substrate, such that the difference between surface tension of a powder coating and that of the primer is not significant, which may prevent a homogenous layer of color from coating the metal substrate. Therefore, the primer is required to have a surface tension that conforms to those of the powder coatings, such to be of substantially the same range.

Another requirement of the primer concerns impact. All powder coatings used for coloring metal substrates that are intended to be implemented as part of exterior surfaces, e.g., exterior surfaces of buildings, conform to standards of weather durability (e.g., durability to humidity, temperature and temperature changes, sun light, etc.), mechanical durability, and any other standard of the sort. Thus, all powders are found to have high impact durability during impact tests. The powder coating which may be initially used to paint a first colored layer onto the metal substrate is connected to the metal substrate by mechanical and physical connections. However, once a primer is used, the connections between the primer and the first colored layer, as well as connections between the primer and the second colored layer, are chemical connections, which are stronger than mechanical and/or physical connections, and which may thus harm the strength of the connection between the first colored layer and the metal substrate. In order to ensure that the primer has high impact durability similarly to the impact durability of the powder coatings, and thus to enable the primer to absorb some of the energy or impact such that the first colored layer would stay intact and properly connected to the metal substrate, materials comprising high elasticity may be added to the primer, for example, resin may be added to the primer. By increasing the elasticity of the primer, the primer's impact durability is raised. In other examples, the adhesion force or adhesion connection between the primer and the first colored layer may be lowered, in order to prevent the primer from weakening the impact durability of the first colored layer.

According to some embodiments, it is important that the primer, and thus the entire painted metal object have good durability under external conditions of the environment for a long time period. For example, the metal object should be designed to withstand extreme weather changes without them causing any harm to the strength and durability of the painted metal object.

When using electrostatic powder coating injecting gun 1820 for applying powder coating comprising a second color (either the same as or different from the first color), the powder attaches to the metal object, thus typically covering the entire side of the metal substrate onto which the powder is sprayed. Furthermore, the powder may also cover at least some of the metal object's sides that are not in direct contact with the sprayed powder coating, e.g., a side that is opposite to the side or face onto which the powder is sprayed. In order to remove excess of the powder coating and thus maintain the powder coating only at the location on the metal object defined by the applied (e.g., printed) primer's location, system 1800 may further comprise a compressed air-gun 1830. Air-gun 1830 may comprise multiple nozzles which air is pressurized therethrough. Air should be pressurized through air-gun 1830 at a high pressure, e.g. around 6-8 bar, in order to properly remove the powder coating from the metal substrate, thus removing powder coating from all around the metal substrate or metal object, except for the powder that is attached onto the primer. That is, the pressure of air-gun 1830 should be lower than the strength of the connection between the powder comprising the second color and the primer. Air-gun 1830 may be required to move around the metal substrate or object in order to ensure that all excess of the powder is removed from all portions of the substrate or object. In some embodiments, air-gun 1830 may comprise a tank for maintaining high pressure of the compressed air, which is to be pressurized out of the nozzles of air-gun 1830. Compressed air is preferably used for removing excess of powder that is not attached to the primer, since air blowing is a very efficient and quick method for removing excess of material, which requires little or no human involvement. However, in other embodiments, other methods of removing excess of powder that is not attached to the primer may be used, for example, brushing excess of powder using special brushes. In which case, instead of air-gun 1830, system 1800 may comprise other corresponding devices for removing excess of powder, e.g., brushes. In some embodiments, the excess of powder may be collected by a designated suction unit. According to some embodiments, the collected excess of powder may be re-used for future powder coating.

In yet other embodiments, air-gun 1830 may not be sufficient enough to remove all excess of the powder coating that is not attached to the primer. In such case, a brushing system 1840 may be implemented as part of system 1800. Such a brushing system 1840 may comprise one or more brushing units, e.g., brushes, which are specifically designed to remove powder not attached to primer on one hand, while not smearing the primer or otherwise changing the predetermined pattern according to which primer and powder coating are to be 3D decorated onto the metal substrate. In some embodiments, the excess of powder may be collected by a designated suction unit that is in communication with the brushing system 1840. According to some embodiments, the collected excess of powder may be re-used for future powder coating.

According to some embodiments, brushing system 1840 ensures proper and distinct 3D decorations along a metal substrate. That is, since the better the process of removing excess of powder unattached to primer is, the more distinct 3D decorations are along a metal substrate, since no powder is present in locations it should not be at. Brushing system 1840 significantly improves the level of cleanliness of a 3D decorated metal substrate, in order to assist in making the 3D decorations more distinct and highly visible. With the addition of brushing unit 1840, substantially endless types of patterns may be property visible as 3D decorations onto a metal substrate.

It is important to avoid any finger prints or any other materials with higher surface tension than that of the powder coating, which may leave marks such as sweaty, fatty or greasy marks from contacting the metal substrate. Fat, grease or sweat may adhere the powder coating such that even after air-blowing the excess of powder that is not attached to the primer, some of the powder coating may still stay attached to the metal substrate in areas where fat, grease or sweat were present, thus interrupting with cleanliness and precision of the predefined pattern. Therefore, in some embodiments, the production line may comprise a cleaning unit for cleaning the surface of the metal substrate after loading the metal substrate onto the production line (and prior to applying the primer) such to ensure a highly clean substrate and high quality of products.

Following removal of excess of powder, such that powder coating remains only at the location on the metal substrate or object defined by the primer, the powder needs to go through a curing process in order to form a strong and stable attachment with the metal substrate (or object, e.g., a metal profile). Preferably, the powder coating is thermal curable powder coating, such that the powder is curable via application of thermal energy. Therefore, system 1800 may comprise convection oven 1850, for curing the thermal curable powder to the metal substrate according to the pattern defined by the primer and to which the powder has attached. The metal substrate may be placed into convection oven 1850, in order to initiate the curing process.

The metal substrate or object cools down and may then be incorporated as part of any structure, e.g., in the building industry. For example, a metal object, e.g., an aluminum extrusion that is colored with one color on one side, while 3D decorated with a second color and/or pattern comprising a second color similar as or different from the first color, implemented on the other side (typically the side opposite the first side) may be implemented as part of a building, such that one side of the extrusion is part of the exterior of the building, and the other side of the extrusion is part of the interior of the building, while each side may have a completely different color and/or pattern. The method of 3D painting or 3D decorating a metal object according to a predetermined pattern on at least one side of a metal object, enables endless designs of metal objects; where one side or one face of the object may have one 3D design, defined by color and/or pattern, which may be completely different compared to the 3D design that a different side or face of the metal object may have.

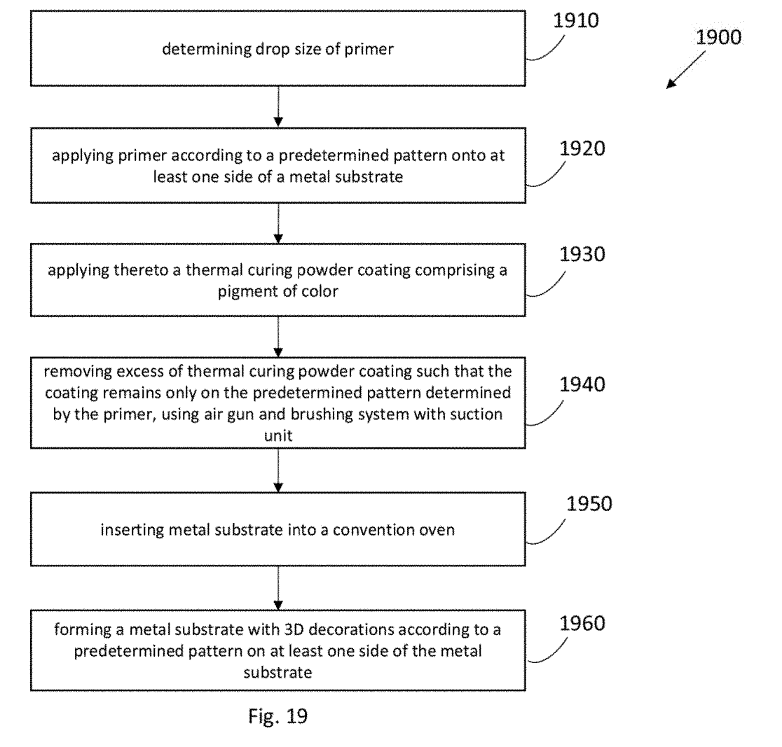

Reference is now made to FIG. 19, which is a flowchart of a method 1900 for 3D decorating a metal substrate according to a predetermined pattern on at least one side of the metal substrate, according to embodiments of the disclosure. Method 1900 may comprise step 1910 comprising determining drop size of primer that is to be applied onto a metal substrate. As explained hereinabove, by defining the drop size of primer, the degree of thickness and thus degree of 3D decorations is defined. Method 1900 may further comprise step 1920 comprising applying the primer according to a predetermined pattern onto at least one side of a metal substrate. In some embodiments, a metal substrate may initially be painted with a first colored layer. The metal substrate may be painted with the first color by any known method of painting metals, e.g., by using thermal curable powder coating, UV curable powder coating, or any other type of coating. The metal substrate is typically uniformly painted with the first color on all sides of the metal substrate.

In step 1920, a primer is applied onto the colored metal substrate according to a predefined pattern, onto at least one side of the metal substrate, such that, for example, one side of the metal substrate may have a first color according to the first colored layer, while another side of the metal substrate may have a primer applied onto it in accordance with a particular pattern thus later causing that side to have a second colored layer according to a particular pattern. In some embodiments, the second color injected onto the primer may be the same as the first color, whereas in other embodiments, the second color may be different from the first color.

The primer is preferably applied via digital printing, though other methods of applying the primer may be implemented. Digital printing is a preferable method of applying the primer according to a predefined pattern, since digital printing is very precise and is quick enough to be used as part of a production line. The predefined pattern is loaded as a digital-based image onto a digital printer adjusted to printing primer. The primer is then digitally printed onto the metal substrate, thus defining the desired pattern and desired degree of pattern thickness above the surface of the metal substrate that should appear on the metal substrate by the second colored layer.

System 1900 may further comprise step 1930, comprising applying a thermal curing powder coating comprising a second color, onto the metal substrate. In other embodiments, other types of powder coatings may be used, for example, UV curable powder coatings. The thermal curable powder coating is typically applied onto the metal substrate using an electrostatic powder coating injecting gun, e.g., gun 1820 in FIG. 18. Injecting the electrostatic powder onto the metal substrate, causes the powder to attach onto the entire area of the side of the metal substrate that the powder is sprayed onto, and may even cause the powder to attach to other sides of the metal substrate. Thus, following application of the powder coating onto the metal substrate, there is no telling of which pattern the primer was printed according to.

Therefore, method 1900 comprises step 1940, which comprises removing excess of thermal curable powder coating such that the coating remains only at a location determined by the primer. Step 1940 of removing excess of the powder coating, typically thermal curing powder coating, is an essential step to ensure powder coating comprising a second color remains only at the location defined by the primer, such that the pattern of the second colored layer is printed onto the metal substrate according to the predefined pattern with high precision and accuracy. Removal of excess of thermal curable powder coating may be done using pressurized air, via an air-gun, e.g., air-gun 1830, though other means may be used. In some embodiments, pressurized air does not provide complete removal of excess of powder, and additional means are required, for example, brushing system 1840, which may comprise one or more brushing units that are configured to gently yet efficiently remove excess of powder off the metal substrate.

In some embodiments, method 1900 may further comprise step 1950, which comprises activating a convection oven in order to cure the thermal curable powder coating. Since the powder coating is preferably thermal curable powder coating, activation of heat is required in order to accomplish curing of the powder coating so as to form a stable coating over the metal substrate. Thermal energy is applied onto the coated metal substrate, via thermal energy source, e.g., convection oven 1850. After a period of approximately 8-12 minutes under approximately 180° C., the powder is fully cured and is uniformly coated onto the metal substrate, according to the particular pattern and thickness in which the primer was printed.

In some embodiments, method 1900 may comprise step 1960 comprising forming a metal substrate with 3D decorations according to a predetermined pattern on at least one side of the metal substrate. At the end of method 1900, a metal substrate may be 3D decorated such that each of the sides of the metal substrate may be decorated with a different design. For example, one side of the metal substrate may comprise a first colored layer (e.g., according to the layer of color used to color the entire metal substrate, prior to the beginning of method 1900), whereas another side of the metal substrate (typically an opposite side) may comprise a 3D second colored layer according to a pattern, in addition to the first colored layer. The 3D pattern according to which the second colored layer may be applied onto at least one side of the metal substrate, may be any visual decoration which may or may not show the first colored layer therethrough. In some embodiments, the pattern according to which the primer is applied onto the metal object may include the entire area of one side or face of the metal object. In such case, it may be possible to avoid use of primer, and merely use the powder gun 120 for applying powder onto the required side or face of metal substrate. It should be noted though, that proper removal of excess of powder is definitely required from all other sides or faces of the metal substrate that should not be colored.

In some embodiments, the pattern may be a multi-colored pattern comprising more than two colors. Thus, the primer may be applied onto the metal substrate colored with a first colored layer, in repeating steps. During each step, the primer may be applied onto the metal substrate per one color that is to be painted thereto with a predetermined degree of thickness above the surface of the metal substrate. That is, the pattern may be divided into pattern portions corresponding to the number of colors that the pattern is made of. In each step, primer is applied/printed onto the metal substrate according to the pattern portion related to one of the colors, following determination of the drop size of the primer. The corresponding powder coating comprising that color may then be applied onto the primer, excess of powder is removed, and the remaining powder is cured. Then primer is applied/printed onto the metal substrate according to a different pattern portion relating to a different color, and the process is repeated until the entire pattern is applied onto the metal substrate.

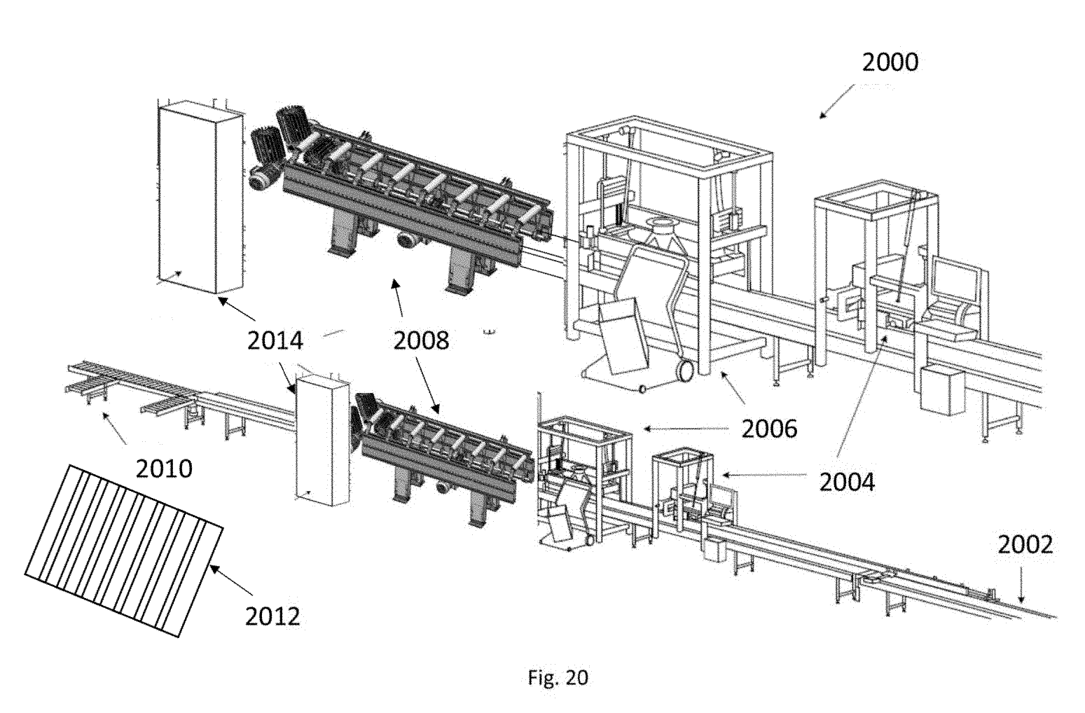

Reference is now made to FIG. 20, which is a schematic illustration of a top-side view of a system for 3D decorating a metal substrate according to a predetermined pattern on at least one side of the metal substrate, according to embodiments of the disclosure. System 2000 may comprise several modules whereby at least some of these modules may be equivalent to the units described in detail with respect to FIG. 18.

In some embodiments, system 2000 may comprise an uploading unit 2002, typically comprising a conveyer, which may be configured to upload a metal substrate, typically in the form of a metal profile, e.g., aluminum profile, into a printing module 2004. Printing module 2004 may comprise a printer, typically a digital printer that has been designed for printing primer on various types of profiles. That is, printing module 2004 may be an adjustable module that adjusts its parameters and characteristics per the metal profile that is inserted therethrough. Printing module 2004 may be equivalent to device 1810 for applying primer (FIG. 18).

In some embodiments, system 2000 may further comprise a powder coating and air-blowing module 2006, which may be configured to apply powder onto the primer that had been printed onto a metal profile by printing module 2004, as well as to blow excess of powder off the metal profile in order to ensure that the powder remains only at the location on the metal profile determined by the printed primer, and thus to avoid attachment of powder to areas along the profile which are not supposed to be colored. Module 2006 may be equivalent to units 1820 and 1830 of FIG. 18.

In some embodiments, system 2000 may comprise a brushing system 2008 that may be configured to brush off excess of powder coating that is not attached onto the primer. Brushing system 2008 may be in addition to air-blowing module 2006. In some embodiments, module 2008 may be equivalent to unit 1840 of FIG. 18.

In some embodiments, system 2000 may further comprise an off-loading area 2010, which may be configured to enable easy and simple off-loading of the colored metal profile into convection oven 2012.

According to some embodiments, system 2000 may comprise a control and electrical supply units 2014, which may be configured to supply power to system 2000, as well as control all modules of system 2000.

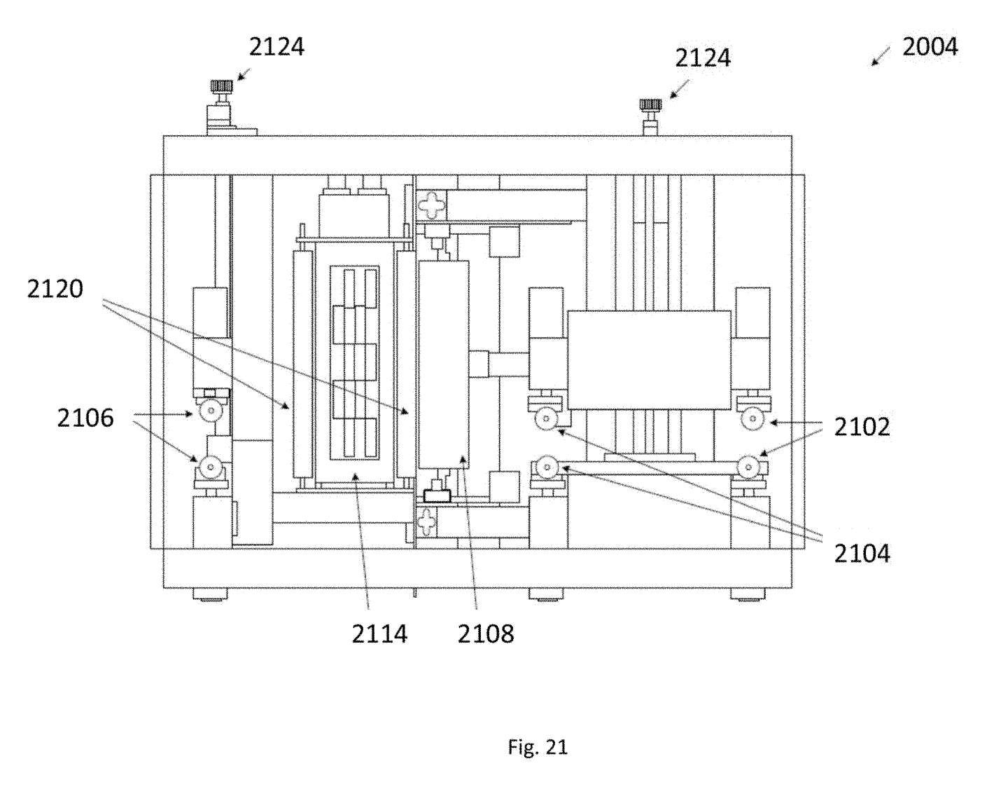

Reference is now made to FIG. 21, which is a schematic illustration of a bottom view of a printing module that is included in a system for 3D decorating a metal substrate according to a predetermined pattern, according to embodiments of the disclosure. Printing module 2004 may receive a metal profile into it via conveyer 2002 (FIG. 20).

The location of the metal profile with respect to printer 2114 should be at a predetermined location, such to determine printing of the primer is according to the predetermined pattern and at the correct location along the metal profile. Accordingly, printing module 2004 may comprise clinching cylinders 2102, 2104 and 2106, which are configured to align the metal substrate, e.g., metallic profile or extrusion with respect to the printer 2114. According to some embodiments, the clinching cylinders may be controlled via a profile localization system 2124. Profile localization system 2124 may control the initial permanent location of the first cylinder of a pair of clinching cylinders, which corresponds to the initial location of printer 2114. In addition, the movement of the second movable cylinder may be controlled via profile localization system 2124. In other embodiments, profile localization system 2124 may control movement of each cylinder of any pair of clinching cylinders 2102, 2104 and 2106.

Each of the clinching cylinders 2102, 2104 and 2106, typically comprise of two cylinders located on opposite sides of conveyer 2002. For example, clinching cylinders 2102 may comprise two opposing cylinders that may clinch and hug the metal profile, such that each of the pair of cylinders 2102 supports and thus aligns one of the sides of the metal profile that is placed onto conveyer 2102. Clinching cylinders 2102 may be positioned at the entrance to printing module 2004. An additional pair of typically opposing clinching cylinders 2104 may be located further along printing module 2004, in order to further support and align the metal profile as it continues to move along conveyer 2002 towards printer 2114.

In some embodiments, printing module 2004 may further comprise an additional set of clinching cylinders 2106, typically including a pair of cylinders located opposite one another, which may provide support and thus align the metal profile as it exits printing module 2004. Since the metal profiles are typically longer than printing module 2004, several pairs of clinching cylinders are required in order to ensure that a metal profile is constantly property aligned with respect to the location of printer 2114.

Clinching cylinders 2102, 2104 and 2106 may slightly push any metal profile according to a predetermined position with respect to conveyer 2002 and with respect to the location of printer 2114, in order to determine that the position of the metal profile conforms to the predetermined pattern that is to be printed thereon by printer 2114. That is, according to some embodiments, clinching cylinders 2102, 2104 and 2106 may be able to move parallel to the longitudinal axis of conveyer 302, and parallel to the longitudinal axis of printing module 2004.

In some embodiments, the distance between each pair of clinching cylinders should be small in order to be effective during operation of alignment of the metal profile, and yet not too small, in order for alignment to be effective. For example, the distance between each pair of clinching cylinders (e.g., cylinders 2102, 2104 and 2106) may be approximately 400 mm.

According to some embodiments, a first cylinder of any pair of clinching cylinders may be permanent such that is may not be moveable. The position of the first clinching cylinder may be predetermined based on the initial position of printer 2114. Accordingly, the second cylinder of any pair of clinching cylinders may be moveable and change, for example via air pressure, such that the position of the second cylinder corresponds to the shape and dimension of the metal profile to ensure the metal profile is clinched and supported between the first cylinder and the second cylinder so it is aligned with respect to location of printer 2114. In other embodiments, the first and second cylinders of any pair of clinching cylinders may be moveable to allow alignment of the metal profile with respect to the location of printer 2114.

According to some embodiments, printing module 2004 may further comprise a height adjustment system (not shown), which may be configured to adjust the distance between printer 2114 and a metal profile that is loaded into printing module 2004, with respect to the dimensions, specifically the height, of the metal profile. The distance between printer 2114 and the media being printed. i.e., a metal profile, should be between 3 mm to 5 mm. The nominal distance of printer 2114 from the metal profile may be adjusted prior to entrance of the metal profile into printing module 2004. If the metal profile has a changing height along its longitudinal axis, this would require printer 2114 to change its height with respect to the printing module 2004, and thus maintain a substantially constant distance between printer 2114 and the metal profile. Accordingly, a height adjustment system (not shown) may comprise a tracing or tracking system (not shown), which may comprise a tracing roller. In cases where the tracing system (not shown), i.e., the tracing roller is in contact with the metal profile, after adjustment of the nominal distance between printer 2114 and the metal profile at entrance of the metal profile into printing module 2004, the metal profile may push the tracing roller upwards, which may cause printer 2114 to be raised at the same distance equivalent to the distance that the tracing roller was pushed upwards by the metal profile. Therefore, a tracing system may be configured to maintain a substantially constant nominal distance between printer 2114 and the metal profile such to ensure proper printing.

According to some embodiments, in order to enable raise of printer 2114, printing module 2004 may comprise a weight balance system (not shown), which may be configured to provide counter weight against the weight of printer 2114. Thus, when tracing system or tracing roller is pushed by a metal profile loaded into printing module 2004, the weight balance system enables printer 2114 to raise accordingly, by balancing the weight of printer 2114.

According to some embodiments, before the location of printing module 2004 there may be positioned a heating unit, such that the surface of a metal profile that is to undergo printing, is first heated. Heating the surface of the metal profile may improve its surface tension, thus optimizing the primer printing onto it.

According to some embodiments, printing module 2004 may comprise protecting cylinder 2120, which may be located adjacent to printer 2114. In some embodiments, printing module 2004 may comprise two protecting cylinders 2120, whereby each of protecting cylinders 2120 may be located on an opposite side of printer 2114. In other embodiments, other numbers and locations of protecting cylinders 2120 may be implemented. Protecting cylinders 2120 may be configured to ensure that there is no contact between printer 2114 and the printed media, i.e., the metal profile, in order to avoid any damage to the printing mechanism, of printer 2114.

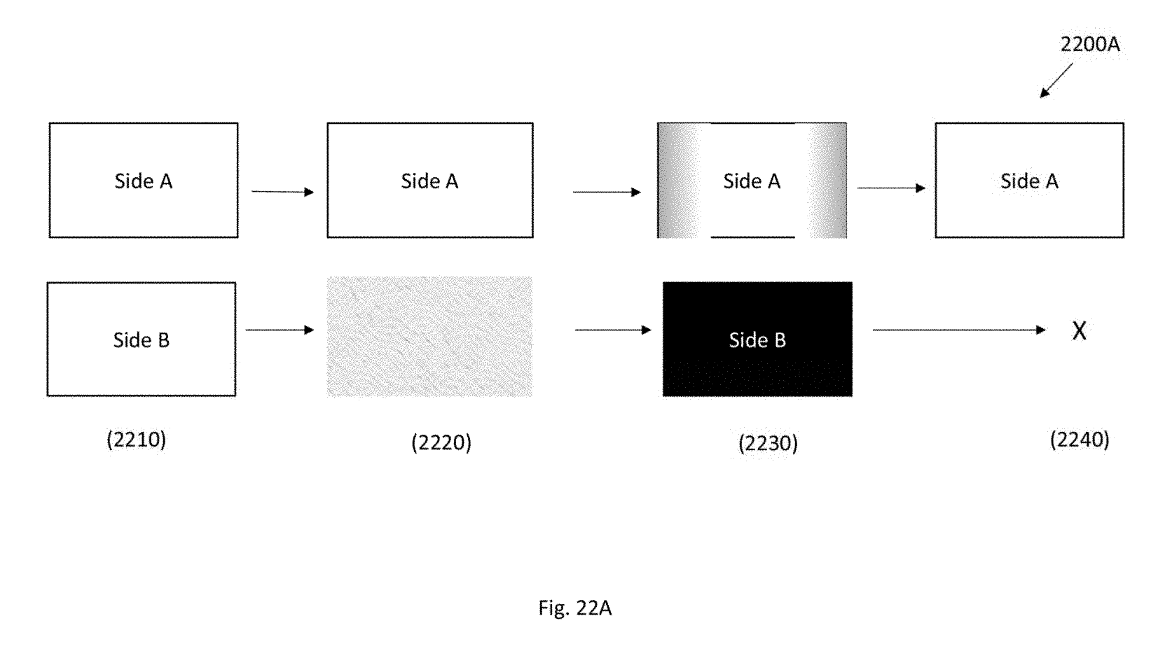

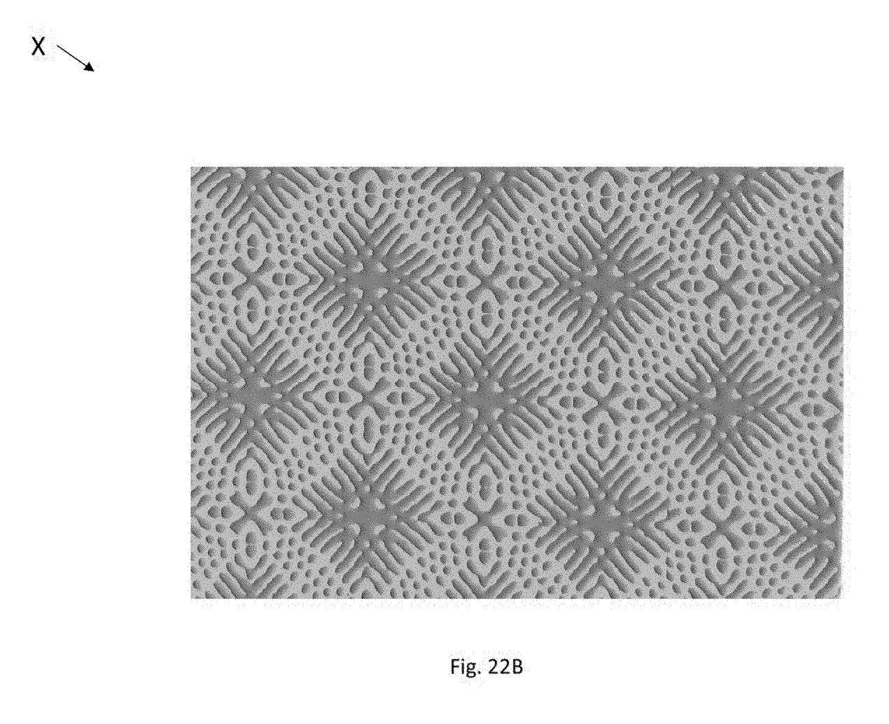

Reference is now made to FIG. 22A, which is a schematic diagram 2200A illustrating the steps of 3D decorating a metal substrate according to a predetermined pattern on one side of the metal substrate, according to embodiments of the disclosure. In step 2210, a metal substrate comprising two sides is entirely painted with a color layer, such that side A and side B are colored with a first colored layer. For example, the first colored layer may be white, though any other color may be coated onto sides A and B. In step 2220, primer is applied onto side B only. Primer may be applied onto side B by digital printing, and may be applied according to a predefined pattern and according to a drop size dictating the amount of primer applied per dot of the predetermined pattern, thus dictating thickness degree of the outcome 3D decoration. In the example illustrated in FIG. 22A, the pattern according to which the primer is applied onto side B of the metal substrate, may be an array of diamonds, with additional inner lines and additional lines in between the diamonds, while the color of the first colored layer may be seen along the pattern. Other patterns may be implemented.

After printing or applying the primer onto side B of the metal substrate, a powder coating is applied onto side B in step 2230. Typically, the powder coating is an electrostatic thermal curable powder coating, which may be sprayed via a powder coating injecting gun, e.g., gun 1820 (FIG. 18). The powder may attach onto the metal substrate, thus coating side B in its entirety, and may even coat at least a portion of side A. In the example illustrated in FIG. 22A, the powder coating may coat side A in a non-uniform manner, e.g., to create a gradient of coated UV curable powder, on one or both ends of side A. The powder coating may comprise—a second color, which may be the same as or may be different from the color of the first colored layer. In the example illustrated in diagram 2200A, the color of the second color is black, though any other color may be used to 3D decorate the metal substrate.

In step 2240, the excess of powder coating is removed from all sides of the metal substrate in order to achieve a metal substrate 3D decorated according to a particular pattern. Removal of excess of powder coating may be performed by air blowing, e.g., using pressurized air blown onto the metal substrate via an air-gun, e.g., air-gun 1830. The force of the pressurized air should be stronger than that of the attachment between the powder coating and the metal substrate, in those sections of the metal substrate where no primer is applied, thus the powder coating remains on side B only in those locations where the powder is attached to the primer. Removal of excess of powder coating may further be performed by a brushing system, e.g., brushing system 1840, which may be connected to a suction unit configured to suck the excess of powder removed by the brushing system.

Reference is now made to FIG. 228, which is a photograph of an example of 3D decorations applied onto a metal substrate, according to embodiments of the disclosure.

Following a curing process of the powder coating, a metal substrate 3D decorated according to a predetermined pattern on one side (e.g., side B), while the other side is decorated with at least one color (e.g., side A), may be formed. In some embodiments, the powder coating may be thermal curable powder coating, such that thermal curing is required in order to form a stable coating on the metal substrate. Thermal curing may be performed via thermal energy sources, e.g., convection cure oven 1850. In other embodiments other types of powder coatings may be used, e.g., UV curable powder coatings, in which case curing may be performed via an IR and UV energy sources.

FIG. 22B is a photograph of one example of practically endless possible 3D decorations. As evident from the decorations of FIG. 22B, the decorations are raised above the surface of the metal substrate, thus causing these decorations to be 3D decorations. The amount of primer applied onto the metal substrate at each point along the predetermined pattern is measured by drop size. The more primer applied onto a specific do of the pattern, the thicker and more raised the decoration is above the surface of the metal substrate, thereby creating a 3D decoration. Since the primer is not a running liquid but rather has relatively high viscosity, the primer enables 3D decorations according to a specific pattern and the amount of primer affect the degree of thickness of the primer at each dot along the pattern, i.e., the more primer applied via the printer, the thicker the 3D decoration is. The shadows seen in FIG. 22B next to each of the shapes of the 3D decoration applied onto the metal substrate demonstrates the fact that the decorations are indeed 3D decorations, i.e., that the decorations according to a predetermined pattern are raised above the surface of the metal object.

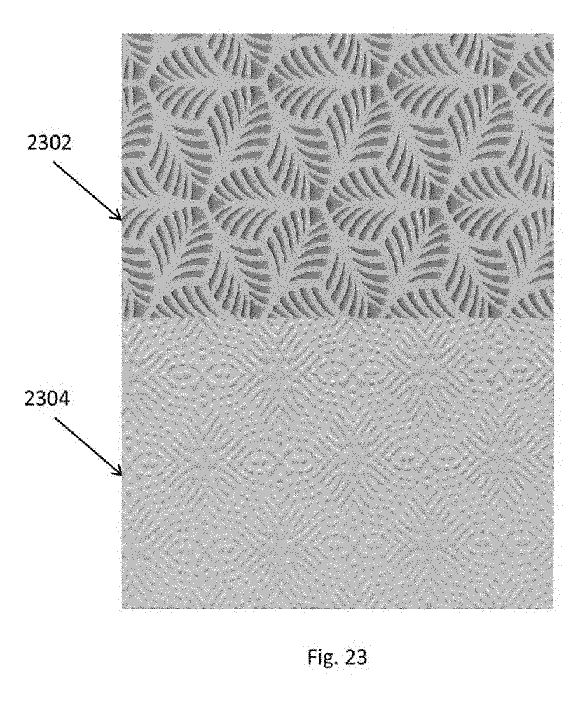

Reference is now made to FIG. 23, which is a photograph of additional examples of 3D decorations applied onto metal substrates, according to embodiments of the disclosure. According to FIG. 23, 3D decoration 2302 comprises a pattern of grey leaves applied onto a white colored metal object. According to FIG. 23, 3D decoration 2304 comprises a pattern similar to that of FIG. 22A-22B, though the color of the 3D decoration in 2304 is white applied onto a white colored substrate. As seen in 3D decoration 2304, although the color applied onto the primer is the same as the color initially applied onto the metal substrate, the fact that this is a 3D decoration, i.e., a thick decoration raised above the surface of the metal object, provides a distinct decoration with respect to the color of the initially colored metal object. Any other colors and any other patterns and 3D degree may be applied according to the present disclosure.

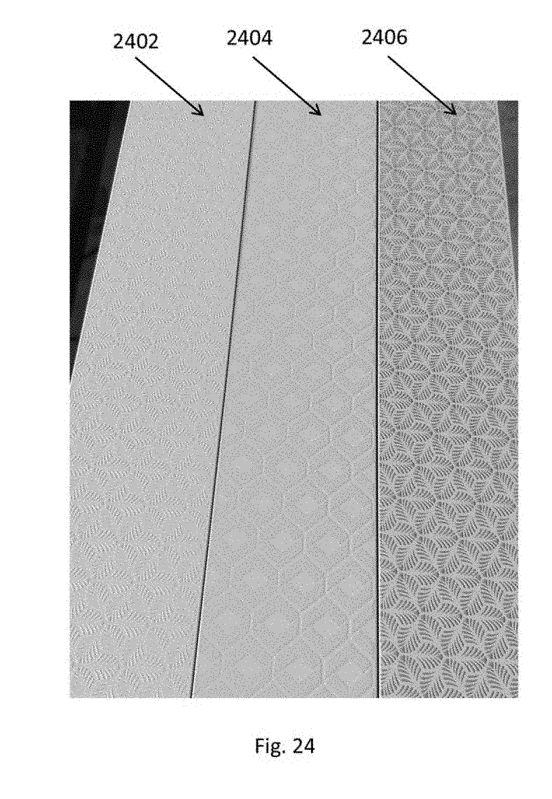

Reference is now made to FIG. 24, which is a photograph of examples of 3D decorations applied onto metal profiles, according to embodiments of the disclosure. According to FIG. 24, 3D decorations according to a predetermined pattern may be applied onto metallic extrusions, e.g., metal profiles to be used as windows frames, and so on. According to FIG. 24, some 3D decorations applied along a metal profile may be of the same color as that of an initially colored metal profile, e.g., profiles 2402 and 2404. The pattern of profiles 2402 and 2404 is different, however, the color applied as part of the 3D decoration is the same as the color initially applied onto the metal profile, which in this case are both colored white. As mentioned before, although the first and second colors are identical, the 3D nature of the decorations makes these decorations distinct and visible with respect to the entire visual and esthetic appearance of the metal profile. In other cases, the second color applied onto the primer may be different from a first color initially applied onto the metal profile, e.g., the 3D decoration applied onto profile 4206. In such case the 3D decoration is colored grey, while the initial color of the metal substrate if white. Any other combination of colors according to any pattern may be applied such to 3D decorate metal profiles, according to the disclosure.

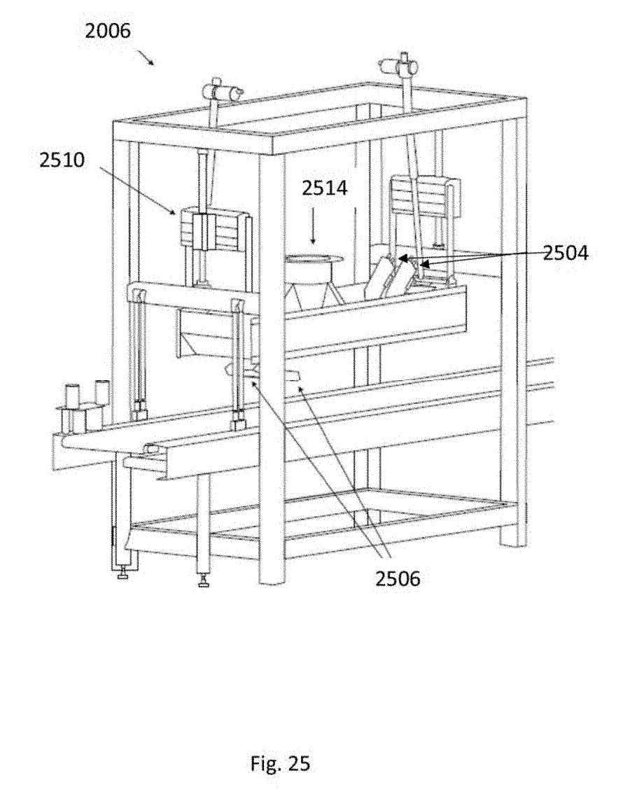

Reference is now made to FIG. 25, which is a schematic illustration of a side-view of a powder coating and air-blowing module, without protecting side walls, according to embodiments of the disclosure. As illustrated in FIG. 20, system 2000 may comprise a powder coating and air blowing module 2006, which may be configured to first inject powder onto a metal profile and then to air-blow excess of powder off the metal profile such that powder would be attached onto the metal prolife only at the locations where primer was printed by printer 2114.

In some embodiments, module 2006 may comprise at least one powder coating gun 2504 that is configured to inject powder onto a metal profile that progresses along conveyer 2002 and thus through all the modules of system 2000. In addition, in order to remove excess of powder off the profile, module 2006 may further comprise air blowing units 2506. Air blowing units 2506 may be located either on one side of powder gun 2504, or on both sides of powder gun 2504. In some embodiments, air blowing units 2506 may be located at various locations along module 2006, e.g., at the proximal end of the profile, following spraying of the powder onto the metal profile that may be carried by conveyer 2002. Other locations and angles of positioning may be adjusted according to the shape of metal profile being painted, and the location of slots along the metal profile.

In some embodiments, module 2006 may further comprise a suction unit (not shown), which may suck the excess of powder that is being removed from the metal profile via air blowing units 2506. The suction unit may be configured to suck the flowing particles of the blown powder that was not attached onto the metal profile via the printed primer. The suction unit may comprise a suction opening 2514. The location of suction opening 2514 may be above the metal profile, typically between the powder coating gun 2504 and some of the air blowing units 2506. The pressure at which powder is sprayed out of powder coating gun 2504 is higher compared to the suction pressure of suction opening 2514, in order to avoid suction opening 2514 from sucking powder when it exits powder gun 2504 and before it reaches the primer printed onto the metal profile.

In some embodiments, the angle at which the at least one powder coating gun 2504 is positioned at within module 2006 and the distance between powder gun 2504 and the metal profile may be adjusted according to the shape of the metal profile, or according to characteristics of the powder and primer, e.g., affinity between the primer and the powder.

According to some embodiments, powder coating and air blowing module 2006 may comprise an elevating unit 2510, which may be configured to elevate the powder coating gun 2504 and/or the air blowing units 2506 in order to maintain these units at a predetermined distance from the treated metal profile.

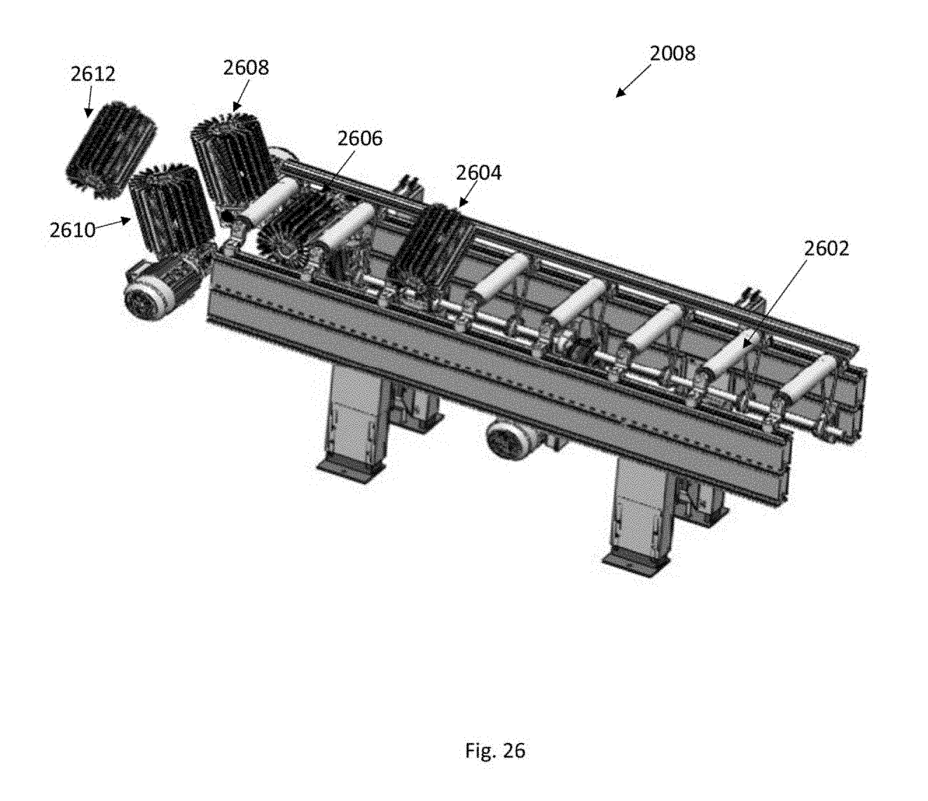

Reference is now made to FIG. 26, which is a schematic illustration of a top-side view of a brushing system, according to embodiments of the disclosure. According to some embodiments, system 2000 may comprise a brushing system 2008, which may be configured to remove excess of powder coating that was not previously removed, e.g., via air blowing gun 2506. In some cases, air blowing is merely not enough for removing all excess of powder coating off areas where primer was not applied onto a metal substrate, and an additional mechanism is required. Brushing system 2008 should be implemented to ensure the pattern according to which primer is applied onto the metal substrate and which is applied with color, should be clean prior to the curing step of the color and primer onto the metal substrate.

In some embodiments, it is necessary to make sure the primer is in solid state prior to using the brushing system to remove excess of powder, in order to make sure that the brushing unit 2008 does not smear or damage the color attached to the primer in any way. In such cases, it may be beneficial to lower the temperature of the primer in order to cool it, to around 15 Celsius degrees in order to make sure the primer is substantially solid state rather than fluidic state, which means that the color applied onto the primer and the primer would not be damaged during application of brushing system 2008. In some embodiments, other low temperatures may be implemented, such to cool the primer prior to passing the metal substrate through brushing system 2008. In some embodiments, the higher the degree of 3D decorations, e.g., the more amount of primer used per decoration, the lower the temperature of primer should be in order to make sure the entire amount of primer is sufficiently cooled and is now in solid state rather than fluidic state.

In some embodiments, the more primer used for 3D decorations, the larger the amount of powder that attaches to the primer, thereby creating a thicker 3D decoration. Roughly speaking, the ratio between amount of primer applied onto a substrate and amount of powder applied onto the primer is 1:2.

In some embodiments, brushing system 2008 may be positioned along or at the sides of a conveyer, or other means for passing metal profiles in close proximity to brushing system 2008, e.g., rollers 2602 located one after the other. In some embodiments brushing system 2008 may comprise at least one brushing unit, e.g., any one or a combination of brushes 2604, 2606, 2608, 2610 and 2612.

According to some embodiments, at least one brush may be located above a moving metal profile, e.g., brushing unit 2604, in order to clean the face or side of the metal profile that was printed with primer and covered with powder coating. In some embodiments, at least one brush may be located beneath a moving metal profile, e.g., brush 2606, in order to clean the bottom part of the metal profile, which may have some excess powder onto it, following the operation of top brush 2604 or prior to the powder removal done via brush 2604. In some embodiments, at least one brush may be located on each side of a moving metal profile, such to remove excess of powder that may be located at the sides of the metal profile, either before or following powder removal by top brush 2604 and bottom brush 2606. For example, side brush 2608 may be located to the right of a moving metal profile, while side brush 2610 may be located to the left of a moving metal profile. In some embodiments, brushing system 2008 may comprise a fifth brushing unit, e.g., brush 2612, which may be located beneath a moving metal profile. In other embodiments, a different number of brushing units, and different locations, and further different orders of locations of brushing units may be implemented as part of brushing system 2008.

In some embodiments, any of the brushing units may be configured to be moveable such that their position may be adjusted according to the shape of the metal substrate. In some embodiments, the height of the bottom brushing units, e.g., brushing units 2606 and 2612 may be adjusted between, for example, ±20 mm, and the angle of each brushing unit may be adjusted between, for example, ±10 degrees. In some embodiments, the angle of each side brushing unit, e.g., side brushing units 2608 and 2610, may be adjusted between, for example, ±30 degrees perpendicularly to the direction of movement of the conveyer along which the metal substrate is moving. Lateral movement of the side brushes 2608 and 2610 may be between, for example, ±20 mm. The distance between the two side brushing units 2608 and 2610 may be between, for example, 0-300 mm.

According to some embodiments, the direction of rotation of each one of brushes 2604, 2606, 2608, 2610, and 2612 may be independently defined. In some examples, nominal speed of each brushing unit may be approximately 300 rpm. The range of speed may be between, for example, 150-500 rpm.

According to some embodiments, brushing system 2008 may be located within a suction unit or be in communication with a suction unit that is configured to suck the excess powder brushed off the metal substrate.

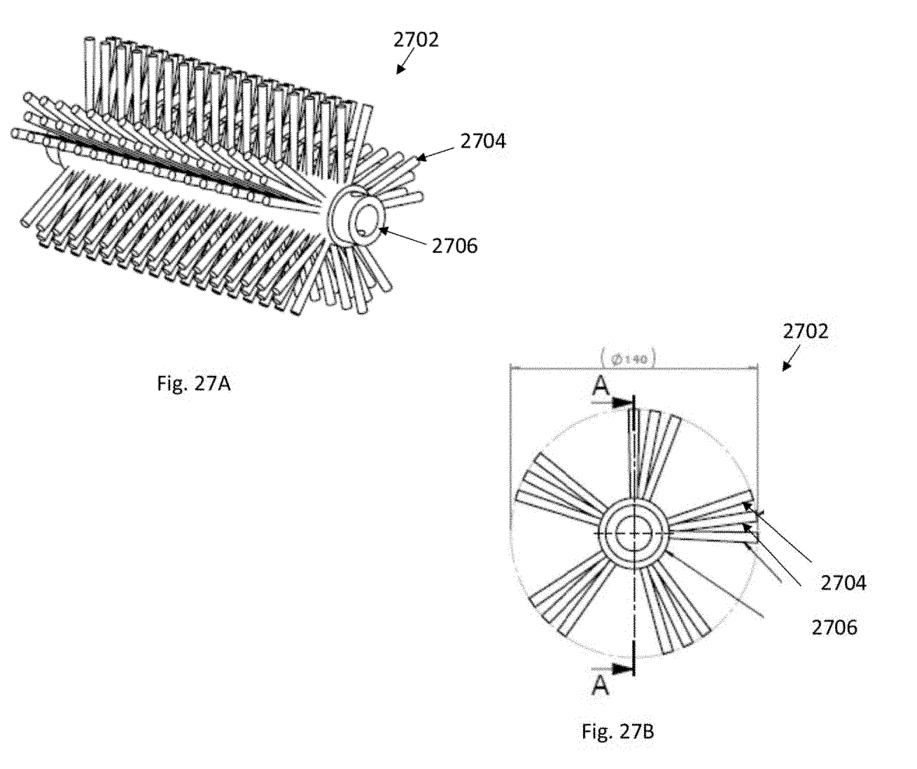

Reference is now made to FIGS. 27A-27B, which are schematic illustrations of a perspective view and a front view, respectively, of a brushing unit, according to embodiments of the disclosure. According to the present disclosure, the brushing system may comprise one or more brushing units that may comprise fibers firm enough to remove excess of powder, while being flexible enough to avoid any damage to the printed primer and color applied and attached onto it. According to some embodiments, each of brushing units 2604, 2606, 2608, 2610 and 2612 (FIG. 26) may be similar to brushing unit 2702. According to some embodiments, brushing unit 2702 may comprise fibers 2704, which may have a thickness of 0.1 mm±0.05 mm. In other embodiments, other fiber thickness may be implemented. The fibers 2704 of brushing unit 2702 may be made of nylon, though other materials firm yet flexible may be used, e.g., other polymers, such as polypropylene, polyethylene, ABS, Teflon, EVA, or any combination thereof. Other materials may be used.

According to the example in FIGS. 27A-27B, brushing unit 2702 may comprise three rows of parallelly positioned fibers 2704, which may be arranged in several groups around body 2706 of brushing unit 2702. For example, the fibers 2704 may be arranged around body 2706 in five groups, each group containing three rows of fibers 2704. In other embodiments, different numbers of rows of fibers 2704 and different numbers of groups located around body 2706 may be implemented in brushing unit 2702. In some embodiments, there may be some space between each group or rows of fibers, in order to enable easy suction of the powder brushed off the metal substrate via operation of at least one brushing unit 2702.

In some embodiments, the length of each of fibers 2704 may be determined such to enable flexibility of the fiber (the longer, the more flexible) while maintaining firmness of fibers 2704 for efficient brushing of powder off the metal substrate. In one example, the length of fibers 2704 may be approximately 50 mm, though other lengths of fibers 2704 may be used.

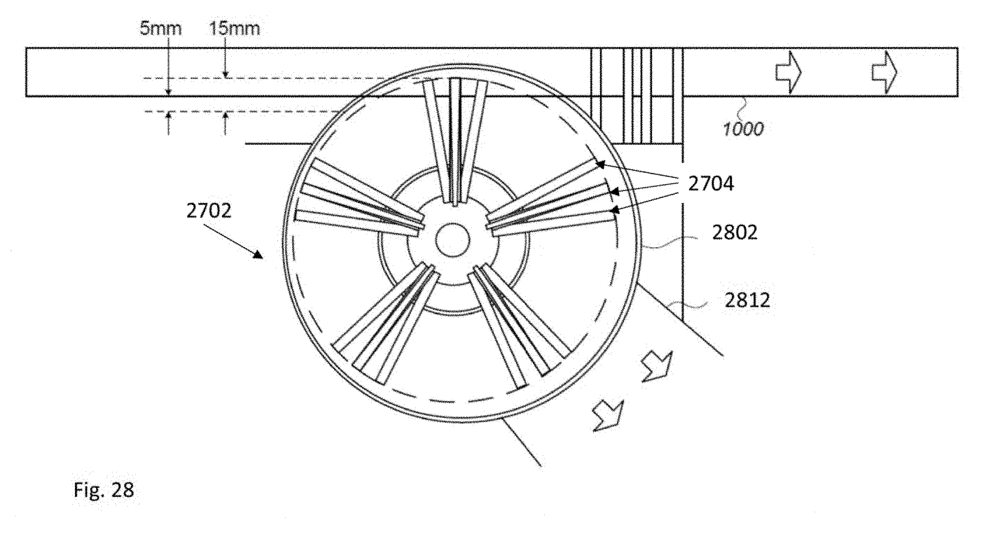

Reference is now made to FIG. 28, which is a schematic illustration of a front view of a brushing unit with respect to a metallic substrate, according to embodiments of the disclosure. According to some embodiments, brushing unit 2702, which may typically be located at one of the sides of a metallic substrate, which is not the side onto which primer was applied (e.g., one of side brushing units 2608 and 2610, FIG. 26), may overlap with a metal profile moving along to be brushed by brushing unit 2702 such to enable removal of excess of powder coating off the metal substrate, e.g., off the sides of the metal substrate, to form a clean and precise 3D decoration pattern along the metal profile. At least one brushing unit 2702, which may be part of brushing system 2008, may overlap with metal profile 1000 along approximately 10 mm of the metal profile. That is, the fibers 2704 of brushing unit 2702 may enter the volume of the metal profile in approximately 10 mm, and may thus brush off powder that may be located, for example on the side of the metal profile, in an efficient manner. In other embodiments, the degree of overlap between the brushing unit fibers 2704 and the metal profile may be different than 10 mm.

In some embodiments, the overlap between a brushing unit that may be located at the side of the metal substrate onto which primer was applied, e.g., top brushing unit 2604 (FIG. 26) and the metal substrate may be determined per shape of metal substrate, and per type of pattern applied onto the metal substrate, in order to efficiently remove excess of powder not applied according to the pattern, while not damaging the pattern by smearing or spreading the primer and color attached onto it.

In some embodiments, the at least one brushing unit 2702 may be in communication with a suction unit 2712 to enable quick suction of excess powder brushed off the metal substrate by the at least one brushing unit 2702.

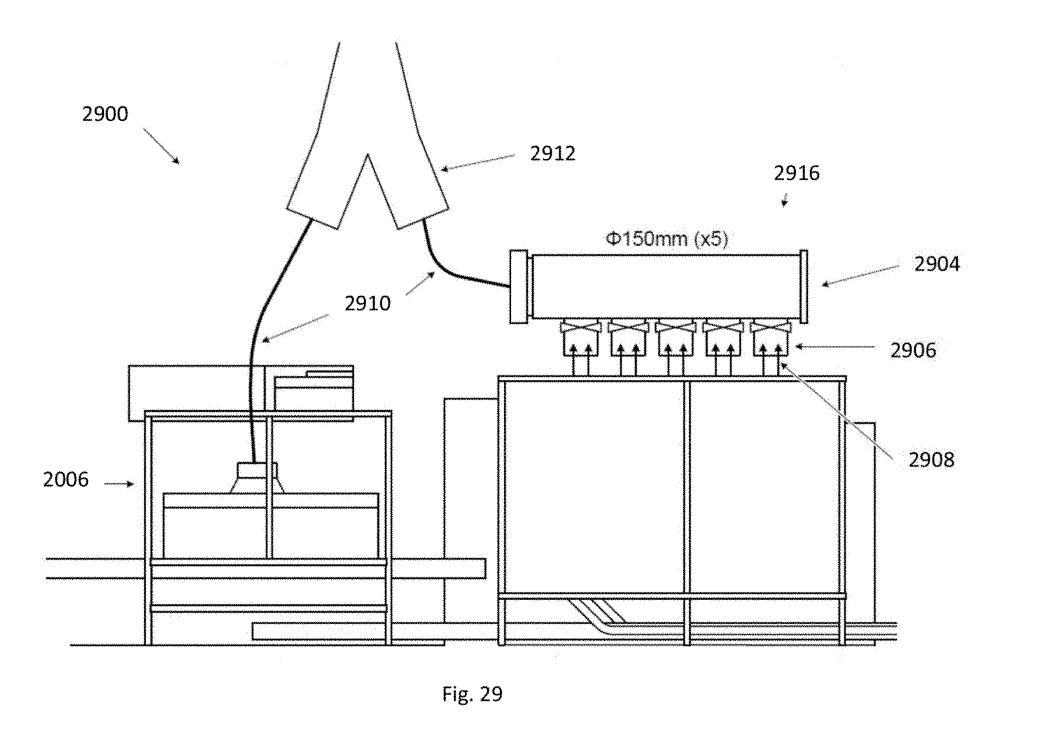

Reference is now made to FIG. 29, which is a schematic illustration of a suction unit 2900, according to embodiments of the disclosure. The suction unit may be in communication with the powder coating and air blowing module 2006 as well as with each of the brushing units of module 2008, which may assist in providing a sufficient cleaning process of the metal substrate from excess of powder. According to some embodiments, suction unit 2912 that is in communication with the air blowing gun 1820 (FIG. 18) of module 2006 may be in communication with brushing system 2008 as well. In some embodiments, suction unit 2912 may comprise a damper (not shown). In some embodiments, the number of dampers 2906 may correspond to the number of brushing units 2702. For example, if five brushes are present (e.g., brushes 2604, 2606, 2608, 2610 and 2612) then five dampers 2906 are also present, one damper for each brushing unit. The plurality of dampers 2906 may be connected to a manifold 2916, which may comprise a cleaning opening 2904.

According to some embodiments, the minimal nominal suction speed is of 15 m/sec. Suction unit 2912 may be configured to treat suction of electrostatic thermal curing powder, e.g., polyester powder and avoid dogging of powder within the tubes of suction system 2912, e.g., tubes 2908 and 2910. The suction system 2912 should be configured to enable cleaning of the suction tubes from the inside as well as continuous maintenance. The suction unit 2912 may be adjustable to brushing units 2702, such to enable easy replacement of these brushes.

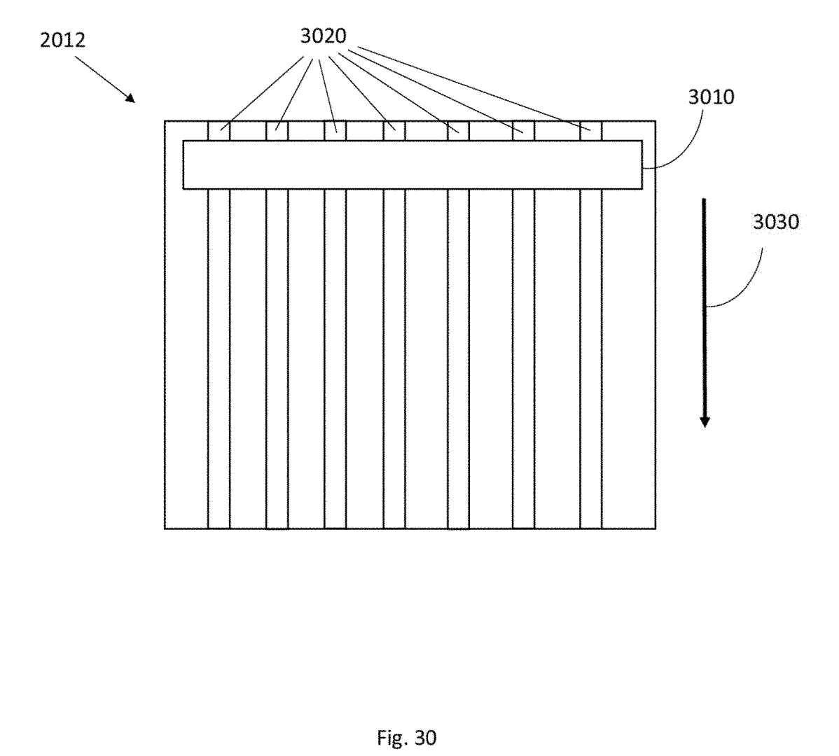

Reference is now made to FIG. 30, which is a schematic illustration of a top view of a transverse loading convection oven, according to embodiments of the disclosure. According to some embodiments, the final step is the curing step, after which a metal substrate decorated with 3D decorations according to a predetermined pattern is formed. In case the powder coating comprising the color applied onto the primer is an electrostatic thermal curable powder coating, the unit operating the curing process may be a convection curing oven 2012. In some embodiments, convection oven 2012 may enable transverse loading of the metal profiles, i.e., the metal profiles pass through convection oven 2012 along their transverse axis and not along their longitudinal axis, as done in conventional ovens in the field of coloring metal profiles. This transverse loading process may shorten the oven's dimensions, since the length of metal substrates along their transverse axis is shorter than their length along their longitudinal axis.

According to some embodiments, a metal profile 3010 may move in transverse direction 3030 along conveyers 3020, during which time the 3D decorations applied onto metal profile 3010 are cured.

In some embodiments, the speed or velocity of operation of transverse loading convection oven 2012 may depend on the width of a metal substrate, e.g., a metal profile. The length of convection oven 2012 may be approximately 5 meters, though other lengths may be implemented. In some embodiments, if a 3D decorated metal profile should exit convection oven 2012 every minute, in case the metal profiles to be cured are thin, convection oven 2012 may operate faster (less curing time required) compared to when the metal profiles are thicker, since a thin profile has less 3D decoration area as opposed to a thick profile that has a larger area of 3D decorations applied thereon, thereby requiring more curing time along convection oven 2012.

In addition, the time to completion of operation of the entire 3D decoration process while maintaining a high quality product, which conforms to a high level of cleanliness so that the 3D decorations are visually distinct, may depend on the following parameters: (i) the number of powder guns that are used to spray the second color onto the printed 3D primer, (ii) the number of brushes used to remove excess of powder of the second color, such that the powder of second color remains only at areas where primer is present, thus conforming with the 3D pattern, (iii) the length of the transverse loading convection oven. Additional of other parameters may also take part in defining the time to completion of the 3D decoration process.

In some embodiments, a metal profile or substrate may advance through system 2000 (FIG. 20) via a conveyer. The conveyer, e.g., conveyer 2002 may be configured to be in the form of a closed loop such to that conveyer 2002 may rotate around the same loop over and over again. Conveyer 2002 may carry a metal profile during the powder and air blowing process along module 2006, and then be directed beneath powder coating and air blowing module 2006 such to return back up adjacently to the opening of module 2006, and so on, thereby creating the closed loop form. In other embodiments, conveyer 2002 may pass along the entire modules of system 2000, may be directed beneath the modules and may return back to the beginning of system 2000, thereby creating the closed loop. In some embodiments, a conveyer cleaning system may be located beneath conveyer 2002, e.g., at a location corresponding to conveyer 2002 being directed beneath system 2000 and before conveyer 2002 returns back up next to the first module of system 2000, e.g., next to printing module 2004. A conveyer cleaning system may comprise, for example, air blowing units, which may blow powder off conveyer 2002, or even brushes semi-soaked in water, in order to clean conveyer 2002 from excess of powder after conveyer 2002 finished to carry one metal profile through system 2000 and before conveyer 2002 carries a new metal profile through system 2000. Cleaning conveyer 2002 may avoid powder from contacting the bottom portion of a new metal profile that may be loaded onto conveyer 2002, and thus avoid coloring the new metal profile not according to the predetermined pattern.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context dearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

What is claimed is:

1. A method for forming a metal substrate with 3D decorations according to a predetermined pattern, on at least one face of the metal substrate, said method comprising:
(g) determining drop size of primer for defining thickness of a 3D decoration;
(h) applying the primer according to a predetermined pattern onto at least one face of a metal substrate;
(i) applying thereto an electrostatic thermal curing powder coating comprising color;
(j) removing excess of electrostatic thermal curing powder coating such that the electrostatic thermal curing powder coating remains only at a location on the metal substrate determined by the primer;
(k) inserting the metal substrate into a convection oven; and
(l) forming a metal substrate with 3D decorations according to the predetermined pattern on the at least one face of the metal substrate.

2. The method according to claim 1, wherein said primer is a thermal based primer.

3. The method according to claim 1, wherein said primer is selected from a group of primers consisting of: UV based primers, solvent based primers and thermal based primers.

4. The method according to claim 1, comprising, prior to applying the primer, entirely painting the metal substrate with a first color or entirely anodizing the metal substrate.

5. The method according to claim 4, wherein said step of entirely painting the metal substrate with a first color comprises applying an electrostatic thermal curing powder coating comprising the first color.

6. The method according to claim 1, wherein the color of the electrostatic thermal curing powder coating is the same as or different from the color of the metal substrate.

7. The method according to claim 1, wherein removing excess of the electrostatic thermal curing powder is performed using air blowing and a brushing unit.

8. The method according to claim 1, wherein said metal substrate is made of a metal selected from a group consisting of: aluminum, iron, copper, steel, stainless steel, and an alloy thereof.

9. The method according to claim 1, wherein steps (a)-(e) are repeated with at least one additional electrostatic thermal curing powder coating of a second color, as determined by a predetermined pattern.

10. The method according to claim 1, wherein said convection oven is is a transverse loading convection oven.

11. A system for forming a metal substrate with 3D decorations according to a predetermined pattern, on at least one face of the metal substrate, said system comprising:
a device for applying a primer according to a predetermined drop size for defining thickness of a 3D decoration and further according to a predetermined pattern onto at least one face of a metal substrate;
a powder gun for spraying electrostatic thermal curing powder coating onto the primer, wherein said electrostatic thermal curing powder coating comprises color;
an air-gun for blowing air onto the electrostatic thermal curing powder coating and a brushing unit for brushing onto the metal substrate for removing excess of electrostatic thermal curing powder such that the electrostatic thermal curing powder coating remains only at the location on the metal substrate determined by the primer; and
a convection oven for curing the electrostatic thermal curing powder coating.

12. The system according to claim 11, wherein said metal substrate is made of a metal selected from a group consisting of: aluminum, iron, copper, steel, stainless steel, and an alloy thereof.

13. The system according to claim 11, wherein said device for applying a primer is a digital printer.

14. The system according to claim 11, wherein said primer is a thermal based primer.

15. The system according to claim 11, wherein said primer is selected from a group of primers consisting of UV based primers, solvent based primers and thermal based primers.

16. The system according to claim 11, wherein the color of the electrostatic thermal curing powder coating is the same as or different from the color of the metal substrate.

17. The system according to claim 11, wherein said convection oven is a transverse loading convection oven.

18. The system according to claim 11, further comprising a second powder gun for entirely painting the metal substrate with a first color, prior to applying the primer.
